(19) United States
(12) Patent Application Publication
(10) Pub. No.: US 2007/0203730 A1
(43) Pub. Date: Aug. 30, 2007

(54) REAL PROPERTY TRANSACTION DATABASE AND METHOD TO MONITOR THE STATUS OF A REAL PROPERTY TRANSACTION

(76) Inventors: ROBERT D. FIRL, TUCSON, AZ (US); CYNTHIA L. NICHOLSON-WASS, TUCSON, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/676,907

(22) Filed: Feb. 20, 2007

Related U.S. Application Data
(60) Provisional application No. 60/774,745, filed on Feb. 17, 2006.

(51) Int. Cl. G06Q 10/00; G06Q 30/00

(52) U.S. Cl. 705/1

(57) ABSTRACT

A method to is disclosed to monitor the status of a real-property transaction. The method supplies a tracking system comprising a server comprising memory, a database encoded in the memory, and a plurality of data input devices in communication with the server, wherein the database comprises a plurality of database fields, wherein one or more access permissions, a data field, a time stamp, an action time, one or more contact persons, and one or more contact alerts, are associated with said of each of the database fields. The method initiates a new real-property transaction wherein a buyer is under contract to purchase real property, and creates in the database a new database entry associated with the new real-property transaction, wherein that new database entry comprises each of the plurality of database fields. The method determines whether to maintain a hard copy file associated with the new real-property transaction. If the method elects to maintain a hard copy file, then the method generates a hard copy file, and attaching a machine-readable label comprising a unique file identifier to that hard copy file, wherein the machine-readable label can be read by each of the plurality of data input devices.

### CROSS REFERENCE TO RELATED APPLICATIONS

This Application claims priority from a U.S. Provisional Application having Ser. No. 60/774,745 filed Feb. 17, 2006.

### FIELD OF THE INVENTION

The invention relates to a real-property transaction database, and method using that database to monitor the status of a real-property transaction.

### BACKGROUND OF THE INVENTION

Prior art methods used to coordinate real-property transactions do not track the quantity of loan files in the system, are not aware of the available staff members, are not aware of the loan types in the system, their complexity, and impact on time completion, and do not have the necessary data to present historical results.

Using prior art methods, hard-copy files are physically moved from person to person, and from office to office. Some prior art methods utilize a manually tracked system requiring users to enter status information utilizing keyboard data entry. These prior art methods are inefficient for the many reasons. For example, the hard copy file does not communicate the information in real time, nor communicate all of the loan processing phases, nor predict the time to complete a particular loan phase.

Moreover, a typical hard copy file does not contain sufficient information such that a user can easily obtain the information to progress the loan to the next phase. In addition, a user is not aware of which staff member(s) are working on a given loan file at a given time. As a result, users are not informed of who to call with questions, concerns and problems. Therefore, users are not informed of what actions need to be taken on their part to assist in the progression.

In addition, prior art files and methods do not inform the financial institution when a loan is falling behind a promised turn time, such as 72 working hours in the underwriting phase. As a result, deadlines are not met, and loan officers and processors are forced to call the financial institution to “rush” the files sometimes after it is too late.

As those skilled in the art will appreciate, when closing dates are not met, potential borrowers lose the home they are contracted to purchase, and the monies deposited in escrow. As a result, the realtor—loan officer, loan officer—financial institution, loan officer—borrower relations are deteriorated, if not ruined.

As a general matter, users have to manually contact the financial institution to obtain status information, adding time to processing the loan file. Because the person answering questions is also the same person processing the loan file, a domino effect is created, affecting every phase of the process and delaying the process for days if not weeks.

Problems inherent with the use of hard copy files and prior methods using those hard copy files, include: potentially causing borrowers losing the home under contract, as well as the escrow deposit, the loan officer is not able to obtain more clients, the loan officer is the main customer service contact for the borrower and appears to be incompetent, the real estate agents no longer believe the loan officer. Moreover, so much delay is introduced, that the financial institution may fail funding the loan on time, and the loan officer(s) subsequently distrust(s) the financial institution, and will not send any new business.

### SUMMARY OF THE INVENTION

The present invention relates generally to financial institutions that wish to associate large amounts of detailed real time information to a plurality of real property transactions. More specifically, the present invention relates to a client-server system, method, and computer program for managing a database operation loan tracking system for holding, managing, and communicating loan data in a consistent manner. The efficiency of this system will afford that financial institution the time to communicate said information to a variety of clients.

In certain embodiments, Applicants' method comprises using a “loan file,” wherein that file resides entirely in a database. In other embodiments, Applicants' method provides a database that facilitates the location and status of a hard-copy loan files.

Regardless of the mode of implementation, Applicants' method allows the data entry user to quickly and efficiently enter the tracking information allowing multiple persons to obtain detailed, accurate real time information. A server-based database replaces the prior art manual file monitoring methods with a database which maintains indices and relations between various data fields, using access permissions, as described further hereinbelow. Also as described further hereinbelow, Applicants' method comprises multiple interfaces that allow multiple persons, subject to access permissions, to read data from the database, and write loan file tracking data back to the database.

Prior art methods monitor only the main loan process phases, such as the time the file arrives at the financial institution, the time the loan file has arrived at the underwriting phase, the time the loan documents have been transmitted to the title company, and the time the loan has funded and/or other information as apparent to those of skill in the art. Although many different phases can require input from the loan officer, the traditional manual tracking system only transmits what is needed from the underwriting phase. Moreover, there is no indication who to contact for questions and concerns for any given phase.

Applicants' method further implements time targets and monitors each loan through every phase, warning users when a loan has fallen behind the set target phase processing times. Applicants' method allow users to be proactive in ushering a loan from phase to phase. Essentially no loan file will ever fall behind and close later than the projected close of escrow date. This is a very significant advantage that will be appreciated by those skilled in the art.

Using Applicants' database for loan tracking provides significant advantages which will be readily appreciated by those of skill in the art. Using a plurality of communication devices and communication links, such as and without limitation, infrared scanning devices, personal computers, micro radio links, telephones, radio frequency identification tags, printers, other applications, personal digital assistants, facsimile machines, persons associated with any loan transaction can request and receive, subject to access permission, the information they require thereby enhancing the overall efficiency of the financial institution staff. Applicants' database provides a common repository for all of the data, which, in turn, allows management from one computer and location, i.e. centralized operation. Additionally, the database server enforces data consistency. Applicants' method will not allow input of invalid data into the database, a facility which is virtually impossible to implement in hard-copy file-based systems.

Applicants' method is implemented by inputting staff names, configuring a plurality of data input devices, i.e. scanners, label makers, and radio frequency identification tags (RFID tags), installing all necessary drivers to interface between a computing device and, for example and without limitation, optical scanners, label makers, telephones, facsimile machines, and the like, thereby performing site integration testing, and configuring the number of staff members working in each department, such as for example setup, underwriting, funding, document creation, underwriting assistants, and the like.

Thereafter, each morning Applicants' method, based upon a procedure of users logging in and logging out, configures the number of staff members working in each department (setup, underwriting, funding, document creation, underwriting assistants, etc.). In addition, Applicants' method constantly monitors users logging in and out and updating the staff member quantity on a department by department basis. Users log in and log out electronically directly into the database. A manager sets target phase processing times. For example, 72 workings hours in the underwriting phase.

Applicants' invention provides several advantages over prior art systems and methods. First, all types of data stored in the database operation loan tracking system server are related to the other types of data in a way that makes generating very flexible and detailed reports very easy. Second, because instructions about each file are stored in the database, the instructions can be modified right up until the time the file has the key code affixed by the receptionist/receiving department. This item is sometimes referred to as late binding.

Third, because all file tracking data is kept in the database, one of the reports that can be generated is loan processing performance. This will greatly assist the management staff in determining which phase needs additional help for efficient allocation of resources. This is sometimes referred to as centralized production/efficiency reports.

Fourth, the identity of each user and each user's access permissions are maintained in the database, and are managed from a single application. This allows management of all users in the financial institution from one central location. Applicants' method allows certain well-trained users to have privileges to perform certain functions that other less well trained users cannot. These designated privileges for each user are managed through Applicants' database. This is sometimes referred to as centralized user privilege management. In addition, this adds a security feature that prevents users from inadvertently compromising data integrity.

Fifth, because expected close of escrow dates are stored within the database, status messages will be transmitted to configured users, indicating due dates are coming soon. Also, the current phase will be transmitted within the message. The message receivers will be better equipped to respond quickly, resolve any outstanding items, maintain excellent customer service, and meet or exceed loan funding by the close of escrow date.

Sixth, because 100 percent paperless file representation is a goal of all financial institutions, Applicants' method comprises one or more user interfaces, which fully support all users to set file status at any loan processing phase. For example, Applicants' method generates graphical user interface information to quickly customize client screen content for a given loan file.

Seventh, in certain embodiments the software can readily be used by the mortgage company staff, including the broker, branch manager, loan officer, processor, and other support staff. In this situation, the user then becomes the mortgage company's employees (broker, loan officer, branch manager, etc.). Applicants' method allows them to track their loans through the unique mortgage company's phases. The ability to track loans at this level would be extremely useful to those skilled in the art.

### BRIEF DESCRIPTION OF THE DRAWINGS

The invention will be better understood from a reading of the following detailed description taken in conjunction with the drawings in which like reference designators are used to designate like elements, and in which:

FIG. 1A is a block diagram showing the elements of Applicants' tracking system;

FIG. 1B is a block diagram showing the elements of Applicants' database;

FIG. 1C is a flow chart summarizing the initial steps of Applicants' method to monitor the status of a real property transaction;

FIG. 1D is a flow chart summarizing additional steps of Applicants' method to monitor the status of a real property transaction;

FIG. 2A is a flow chart summarizing the initial steps of Applicants' method to process a real property transaction;

FIG. 2B is a chart illustrating certain database fields that correspond to each of the method steps recited in FIG. 2A;

FIG. 2C is a chart illustrating buyer access permissions for each of the database fields of FIG. 2A;

FIG. 2D is a chart illustrating broker access permissions for each of the database fields of FIG. 2A;

FIG. 2E is a chart illustrating loan officer access permissions for each of the database fields of FIG. 2A;

FIG. 2F is a chart illustrating appraiser access permissions for each of the database fields of FIG. 2A;

FIG. 3A is a flow chart summarizing additional steps of Applicants' method to process a real property transaction;

FIG. 3B is a chart illustrating certain database fields that correspond to each of the method steps recited in FIG. 3A;

FIG. 3C is a chart illustrating buyer access permissions for each of the database fields of FIG. 3A;

FIG. 3D is a chart illustrating broker access permissions for each of the database fields of FIG. 3A;

FIG. 3E is a chart illustrating loan officer access permissions for each of the database fields of FIG. 3A;

FIG. 3F is a chart illustrating appraiser access permissions for each of the database fields of FIG. 3A;

FIG. 4A is a flow chart summarizing additional steps of Applicants' method to process a real property transaction;

FIG. 4B is a chart illustrating certain database fields that correspond to each of the method steps recited in FIG. 4A;

FIG. 4C is a chart illustrating buyer access permissions for each of the database fields of FIG. 4A;

FIG. 4D is a chart illustrating broker access permissions for each of the database fields of FIG. 4A;

FIG. 4E is a chart illustrating loan officer access permissions for each of the database fields of FIG. 4A;

FIG. 4F is a chart illustrating appraiser access permissions for each of the database fields of FIG. 4;

FIG. 5A is a flow chart summarizing additional steps of Applicants' method to process a real property transaction;

FIG. 5B is a chart illustrating certain database fields that correspond to each of the method steps recited in FIG. 5A;

FIG. 5C is a chart illustrating buyer access permissions for each of the database fields of FIG. 5A;

FIG. 5D is a chart illustrating broker access permissions for each of the database fields of FIG. 5A;

FIG. 5E is a chart illustrating loan officer access permissions for each of the database fields of FIG. 5A;

FIG. 5F is a chart illustrating appraiser access permissions for each of the database fields of FIG. 5A;

FIG. 6A is a flow chart summarizing additional steps of Applicants' method to process a real property transaction;

FIG. 6B is a chart illustrating certain database fields that correspond to each of the method steps recited in FIG. 65A;

FIG. 6C is a chart illustrating buyer access permissions for each of the database fields of FIG. 6A;

FIG. 6D is a chart illustrating broker access permissions for each of the database fields of FIG. 6A;

FIG. 6E is a chart illustrating loan officer access permissions for each of the database fields of FIG. 6A;

FIG. 6F is a chart illustrating appraiser access permissions for each of the database fields of FIG. 6A;

FIG. 7A is a flow chart summarizing additional steps of Applicants' method to process a real property transaction;

FIG. 7B is a chart illustrating certain database fields that correspond to each of the method steps recited in FIG. 7A;

FIG. 7C is a chart illustrating buyer access permissions for each of the database fields of FIG. 7A;

FIG. 7D is a chart illustrating broker access permissions for each of the database fields of FIG. 7A;

FIG. 7E is a chart illustrating loan officer access permissions for each of the database fields of FIG. 7A;

FIG. 7F is a chart illustrating appraiser access permissions for each of the database fields of FIG. 7A;

FIG. 8A is a flow chart summarizing additional steps of Applicants' method to process a real property transaction;

FIG. 8B is a chart illustrating certain database fields that correspond to each of the method steps recited in FIG. 8A;

FIG. 8C is a chart illustrating buyer access permissions for each of the database fields of FIG. 8A;

FIG. 8D is a chart illustrating broker access permissions for each of the database fields of FIG. 8A;

FIG. 8E is a chart illustrating loan officer access permissions for each of the database fields of FIG. 85A;

FIG. 8F is a chart illustrating appraiser access permissions for each of the database fields of FIG. 8A;

FIG. 9A is a flow chart summarizing additional steps of Applicants' method to process a real property transaction;

FIG. 9B is a chart illustrating certain database fields that correspond to each of the method steps recited in FIG. 9A;

FIG. 9C is a chart illustrating buyer access permissions for each of the database fields of FIG. 9A;

FIG. 9D is a chart illustrating broker access permissions for each of the database fields of FIG. 9A;

FIG. 9E is a chart illustrating loan officer access permissions for each of the database fields of FIG. 9A;

FIG. 9F is a chart illustrating appraiser access permissions for each of the database fields of FIG. 9A;

FIG. 10A is a flow chart summarizing additional steps of Applicants' method to process a real property transaction;

FIG. 10B is a chart illustrating certain database fields that correspond to each of the method steps recited in FIG. 5A;

FIG. 10C is a chart illustrating buyer access permissions for each of the database fields of FIG. 10A;

FIG. 10D is a chart illustrating broker access permissions for each of the database fields of FIG. 10A;

FIG. 10E is a chart illustrating loan officer access permissions for each of the database fields of FIG. 10A; and

FIG. 10F is a chart illustrating appraiser access permissions for each of the database fields of FIG. 10A.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

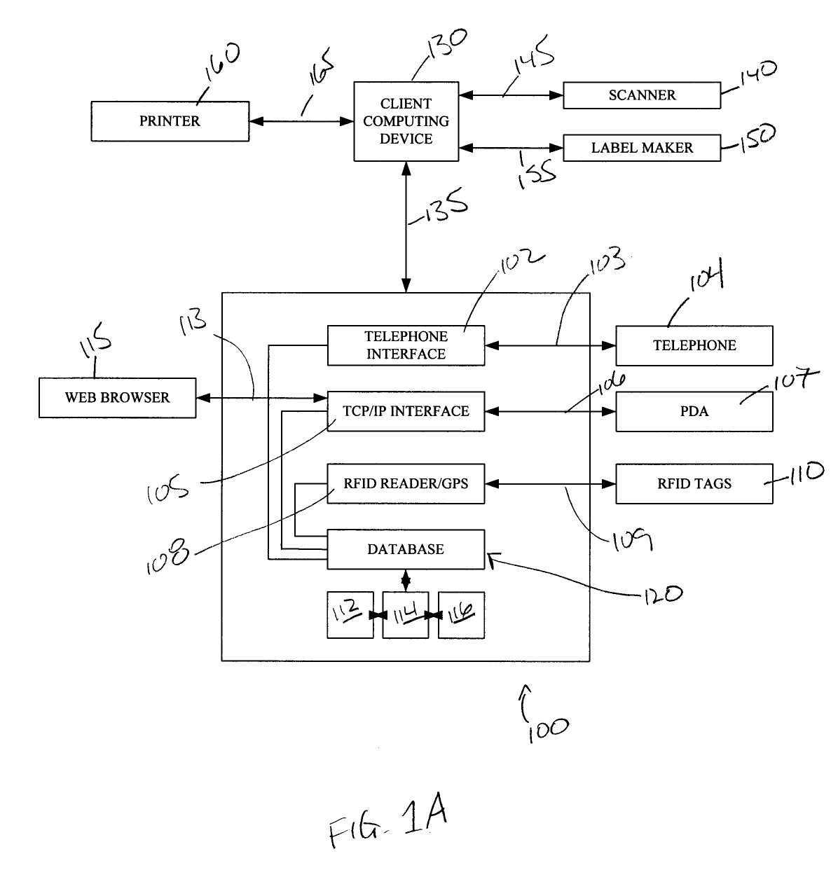

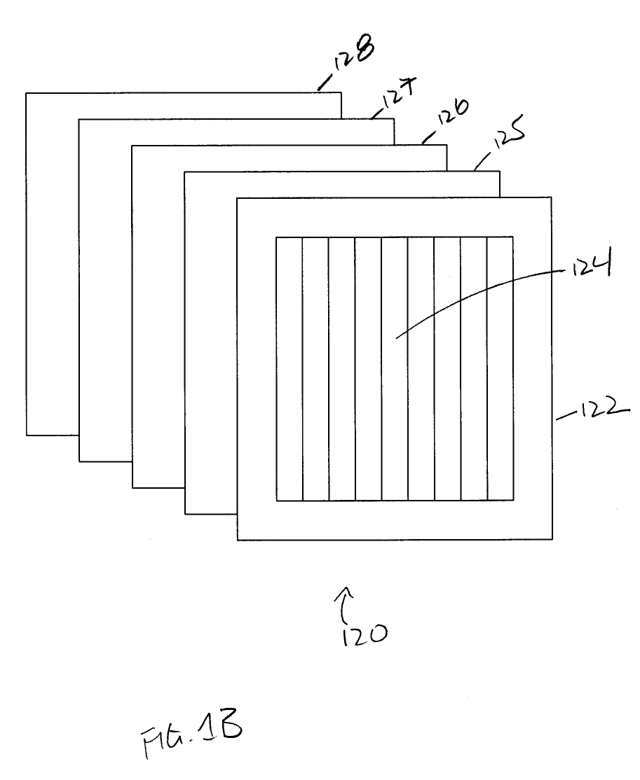

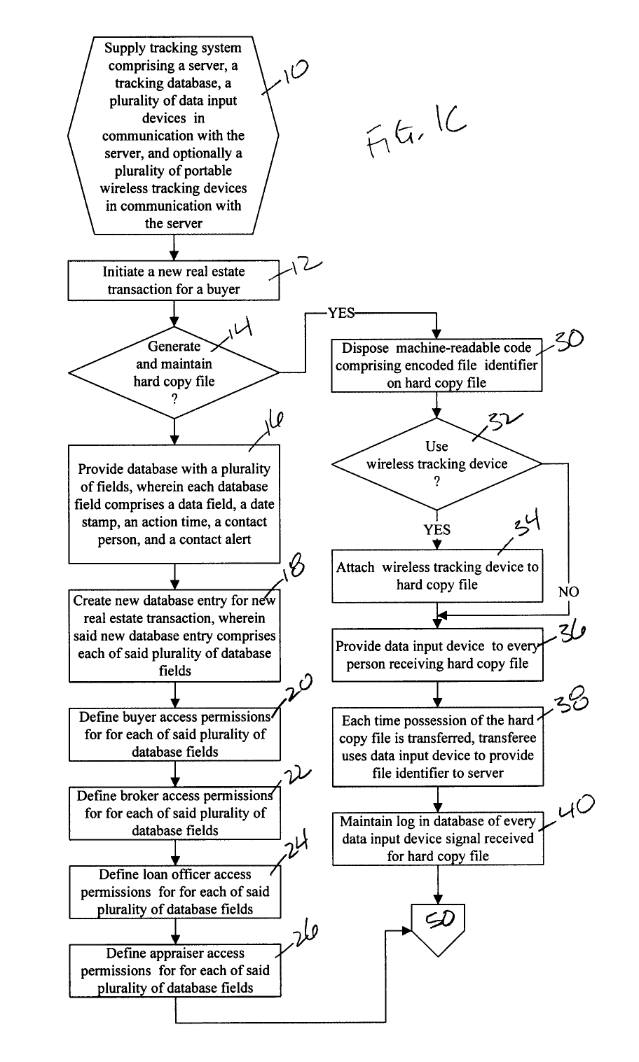

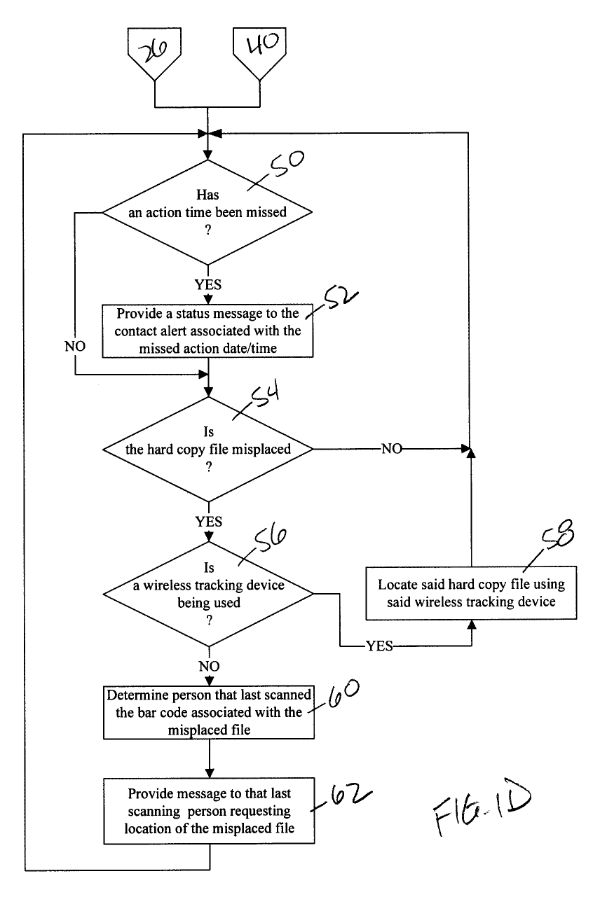

Referring now to FIG. 1A, Applicants' method utilizes server 100 comprising a telephone interface 102, an Internet interface 105, an radio frequency identification reader device 108, and database 120. Telephone interface 102, Internet interface 105, and RFID reader 108 are interconnected with database 120 such that, subject to access permissions described hereinbelow, data may be written to database 120, and/or read from database 120, using a telephone, such as telephone 104 via communication link 103.

Subject to access permissions described hereinbelow, data may be written to database 120, and/or read from database 120, using a personal digital assistant (“PDA”) in communication with the Internet interface 105 via communication link 105. By PDA, Applicants mean a handheld device that combines computing, telephone/fax, Internet and networking features. A typical PDA can function as a cellular phone, fax sender, Web browser and personal organizer. Unlike portable computers, most PDAs began as pen-based, using a stylus rather than a keyboard for input. This means that they also incorporated handwriting recognition features. Some PDAs can also react to voice input by using voice recognition technologies. PDAs of today are available in either a stylus or keyboard version. Subject to access permissions described hereinbelow, data may be written to database 120, and/or read from database 120, using a web browser disposed in a computer via communication link 113.

Subject to access permissions described hereinbelow, data may be input into database 120 from one or more RFID tags 110, or from a scanning device 140 via computing device 130 and communication link 135, and/or from an RFID tag via communication link 109 and RFID reader/GPS device 108. Subject to access permissions described hereinbelow, data may be abstracted from database 120 and printed using printer 160 and/or label maker 150 using computing device 130, communication link 135, and either communication link 165 or 155, respectively.

In certain embodiments, communication links 103, 106, 109, 113, 135, 145, 155, and 165, are each individually selected from a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, one or more of communication links 103, 106, 109, 113, 135, 145, 155, and 165 are compliant with Bluetooth communication protocols using wireless signals at about 2.4 GHz. In certain embodiments, one or more of communication links 103, 106, 109, 113, 135, 145, 155, and 165 are compliant with one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for example projector 100, and a base station or between two wireless clients. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or Wi-Fi, which comprises an extension to 802.11 that applies to wireless LANS and provides up to about 11 Mbps transmission in the 2.4 GHz band; and/or (iv) specification 802.11g which applies to wireless LANs and provides 20+ Mbps in the 2.4 GHz band.

Referring now to FIG. 1B, database 120 comprises a plurality of individual transactions files, such as file 122, file 125, file 126, file 127, and file 128. Each transaction file comprises, at a minimum, all the data traditionally recorded in prior art hard copy files. Each transaction file comprises a plurality of database fields 124.

In certain embodiments, database 120 further comprises personnel tracking fields. In these embodiments, each employee of a mortgage broker and/or financial institution logs into the system and out of the system each working day. These log in and log out times are saved in database 120. Furthermore, each employee of a mortgage broker and/or financial institution enters each task performed, and the time expended to perform that task, on each loan file processed by that person during each working day.

This performance data can be abstracted from Applicants' database to gain a retrospective overview of employee productivity. In addition, this performance data can be used to prospectively to predict loan processing times based upon the number of employees logged into the system. In certain embodiments, Applicants' method allows system administrators to review the encoded performance data, and to enter certain predicted times. For each, performance data abstracted from Applicants' database might support a prediction that, on the average, a total of eight employee-hours is required to underwrite a real property transaction file. A system administrator may elect, however, to enter a “predicted” underwriting time of sixteen hours thereby interjecting a “time cushion” into the predictive process.

System users include borrowers, loan officers, real estate brokers, and appraisers. Based upon certain access permissions described hereinbelow, these system users can access information encoded in Applicants' database. Subject to a user's access permissions, Applicants' method can provide reports, both retrospectively and prospectively, to the users. Such reports can be made in any format, including without limitation hard copy, soft copy, visual displays viewed using a computing device and a browser program, audiovisual displays viewed using a computing device and a browser program, and the like.

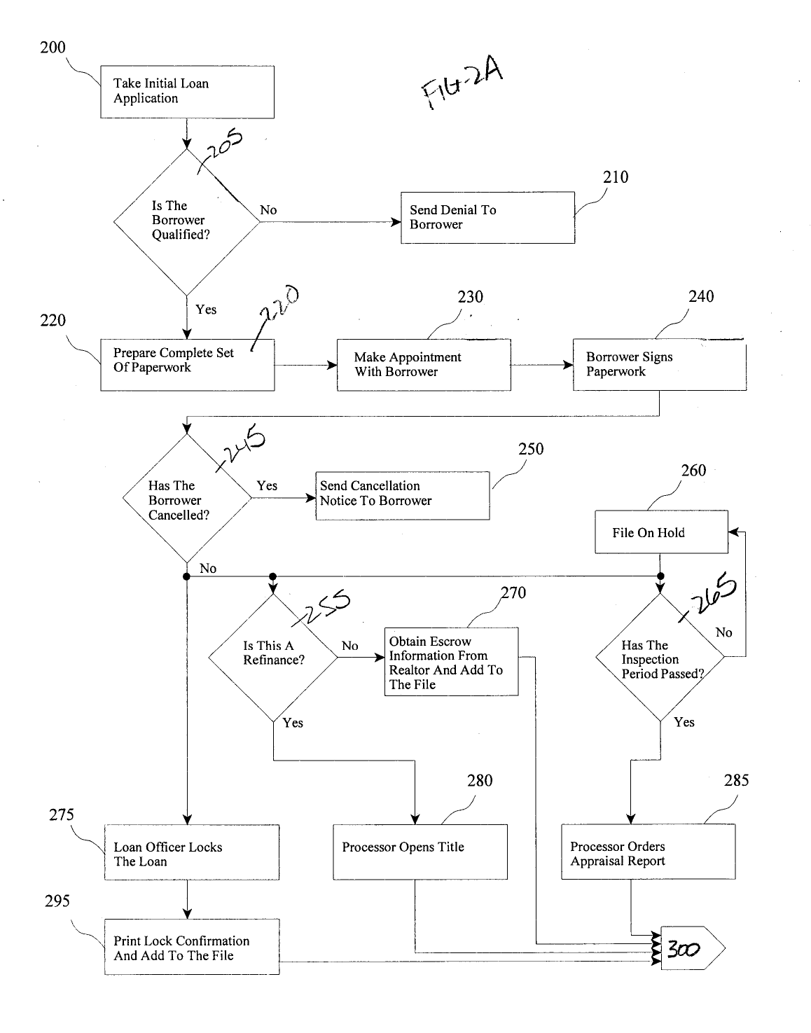

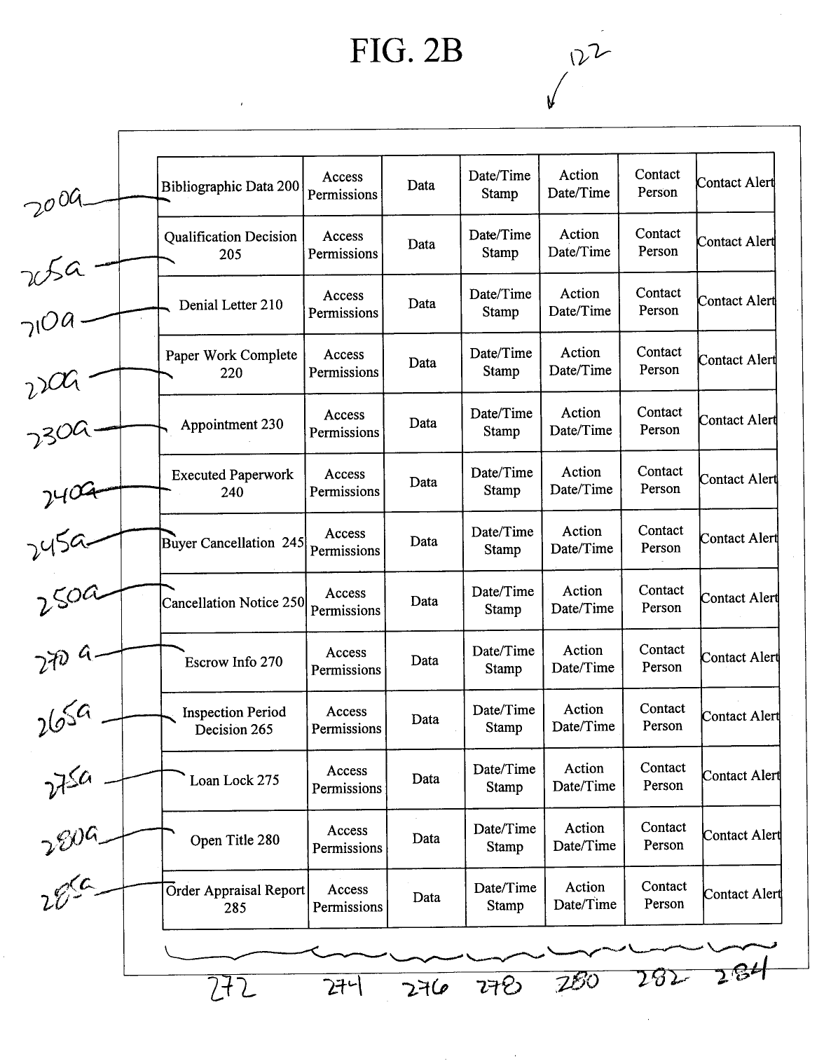

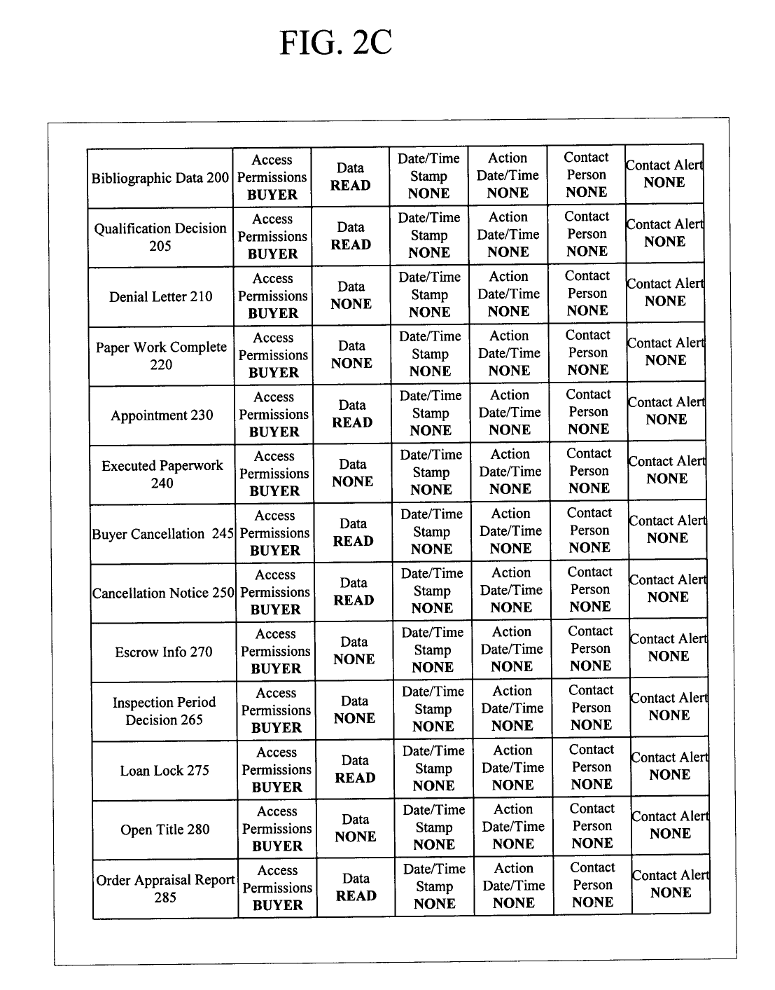

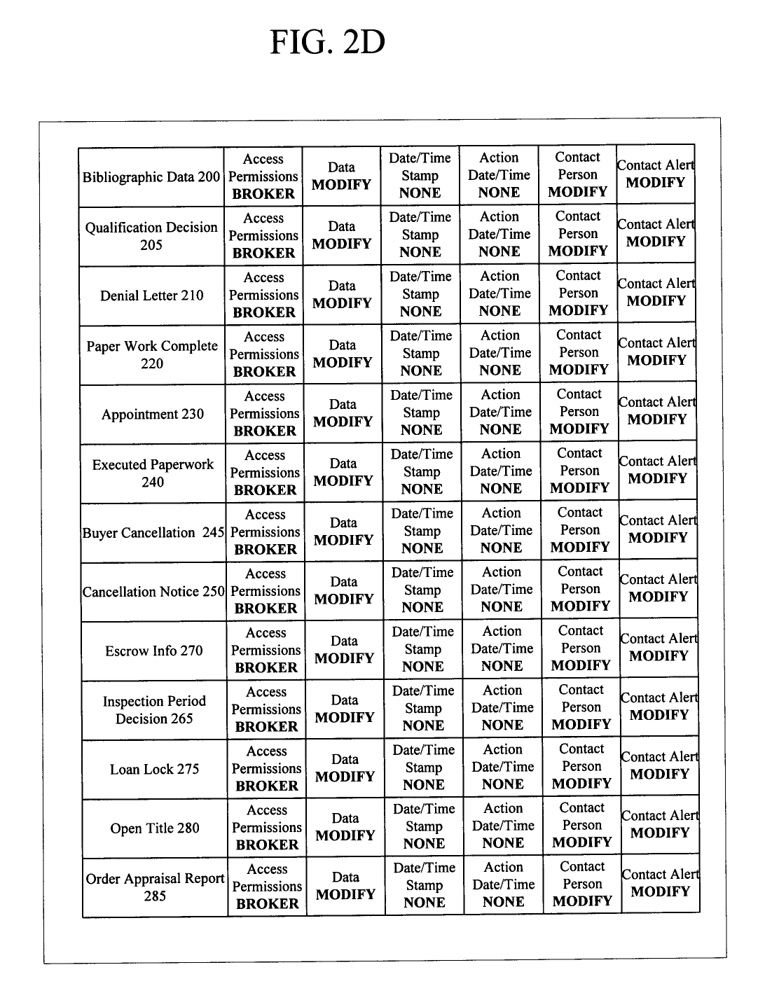

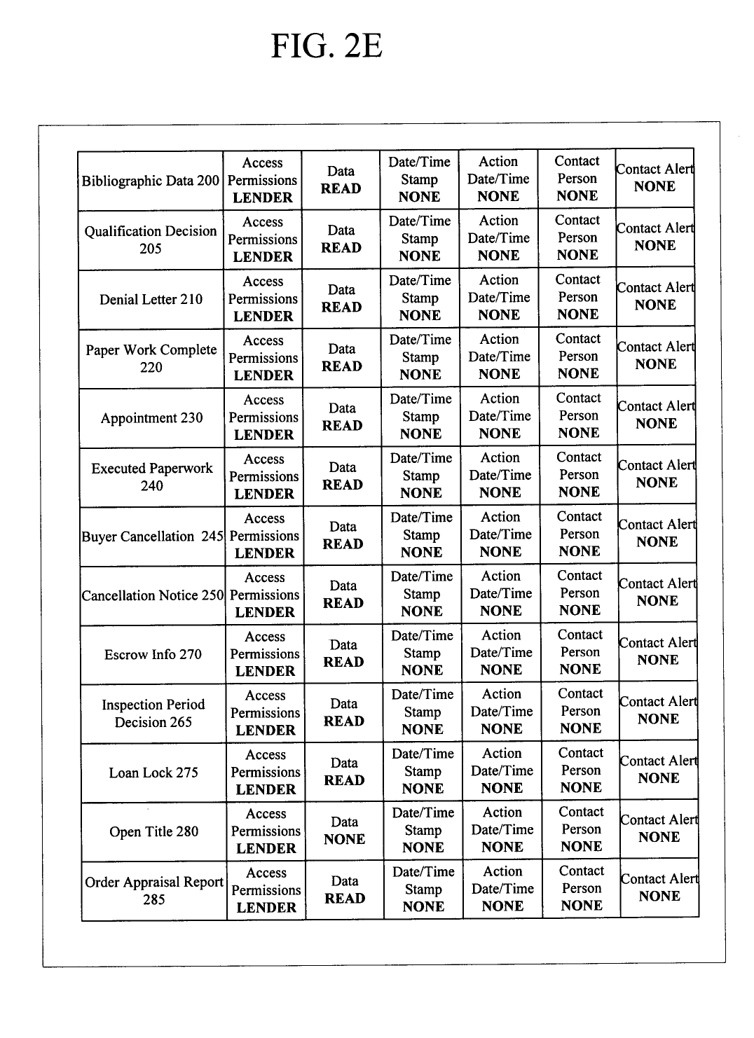

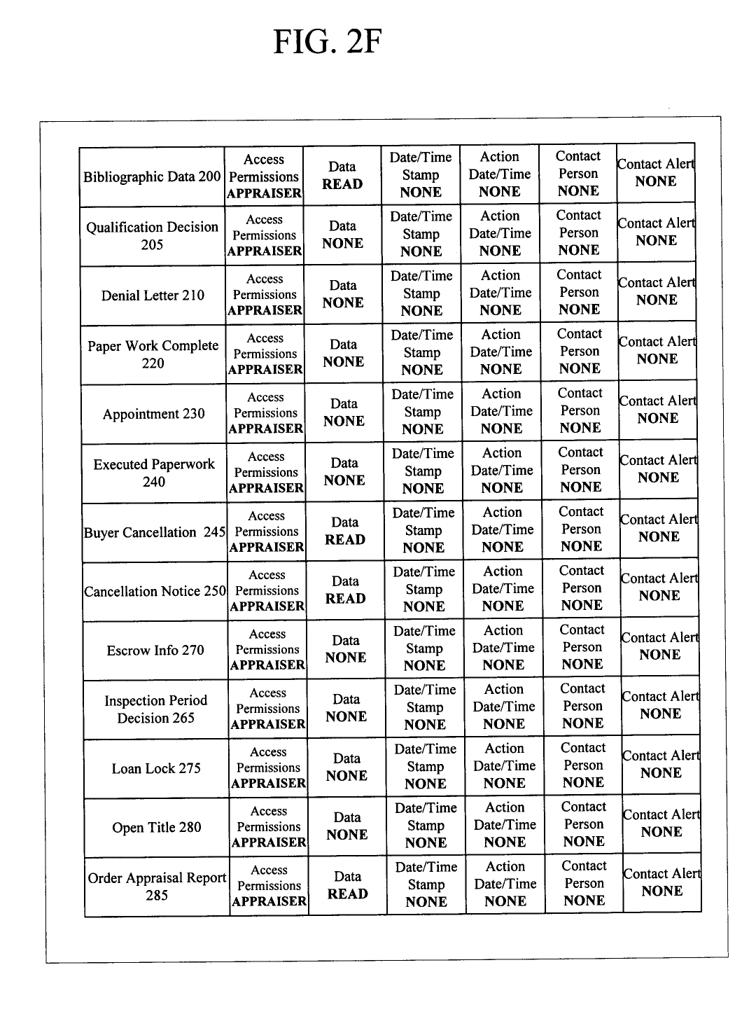

For example in certain embodiments, Applicants' method will abstract performance data from Applicants' database and generate one or more reports, as described hereinabove, for a mortgage broker and/or a financial institution analyzing the performance of employees with respect to a designated loan processing task. Such a loan processing task may comprise any one or more of the loan processing steps recited in FIGS. 2A, 3A, 4A, 5A, 6A, 7A, 8A, 9A, and/or 10A.

In certain embodiments, Applicants' method will abstract performance data from Applicants' database and generate one or more reports, as described hereinabove, for a mortgage broker and/or a financial institution analyzing the average time to process a plurality of loan applications, wherein the processing for each of those loan applications includes one or more of the loan processing steps recited in FIGS. 2A, 3A, 4A, 5A, 6A, 7A, 8A, 9A, and/or 10A.

In certain embodiments, Applicants' method will abstract performance data from Applicants' database and generate one or more reports, as described hereinabove, for a real estate broker with respect to a designated real property transaction. In certain embodiments, Applicants' method will abstract performance data from Applicants' database and generate one or more reports, as described hereinabove, for a mortgage broker and/or a financial institution showing a daily log of loan processing tasks performed for a designated real property transaction.

Applicants' method comprises a method to generate and track a soft copy file, and optionally a hard copy file. Applicants' method further comprises a method to determine the physical location of such a hard copy file.

Referring now to FIG. 1C, in step 10 Applicants' method supplies a tracking system comprising a server, a database, a plurality of data input devices in communication with the server, and optionally a plurality of portable wireless tracking devices in communication with the server. In certain embodiments, the plurality of data input devices comprises a plurality of optical scanning devices.

In certain embodiments, each data input device of step 10 is in communication with Applicants' server. In certain embodiments, each of the plurality of data input devices comprises a unique identifier. When one of the data input devices of step 10 provides information to the server of step 10 that data input device also provides its unique identifier to the server also.

In step 12, Applicants' method initiates a new real estate transaction, wherein a buyer has entered into a contract for the purchase of real property. In step 14, Applicants' method determines whether to generate and maintain a hard copy file for the new real estate transaction of step 12. Whether or not Applicants' method elects in step 14 to generate and maintain a hard copy file, Applicants' method comprises steps 16, 18, 20, 21, 22, 24, and 26.

In step 16, Applicants' method provides a database comprising a plurality of database fields, wherein each database field comprises a data field, a date stamp indicating the last time the data field was revised, an action time whereunder that step of Applicants' transaction method recited in FIGS. 2A, 3A, 4A, 5A, 6A, 7A, 8A, 9A, and 10A must be performed, a contact person to answer questions pertaining to the information recited in the data field, and a contract alert who is contacted if the action time passes without the step being performed. In step 18, Applicants' method creates a new database entry for the new real estate transaction, wherein that new database entry comprises each of the database fields of step 16.

In step 20, Applicants' method defines buyer access permissions for each of the plurality of database fields. If a buyer request access to a specified database field, Applicants' method determines if the buyer access permissions permit the buyer to access the specified database field. If Applicants' method determines that the buyer access permissions permit the buyer to access the specified database field, then Applicants' method grants the buyer's access request. If Applicants' method determines that the buyer access permissions do not permit the buyer to access the specified database field, then Applicants' method denies the buyer's access request.

In step 22, Applicants' method defines broker access permissions for each of the plurality of database fields. If the buyer engages the services of a real estate broker, and if that broker requests access to a specified database field, Applicants' method determines if the broker access permissions permit the broker to access the specified database field. If Applicants' method determines that the broker access permissions permit the broker to access the specified database field, then Applicants' method grants the broker's access request. If Applicants' method determines that the broker access permissions do not permit the broker to access the specified database field, then Applicants' method denies the broker's access request.

In step 24, Applicants' method defines loan officer permissions for each of the plurality of database fields. If the buyer borrows money from a financial institution that employs a loan officer, and if that loan officer requests access to a specified database field, Applicants' method determines if the loan officer access permissions permit the loan officer to access the specified database field. If Applicants' method determines that the loan officer access permissions permit the loan officer to access the specified database field, then Applicants' method grants the loan officer's access request. If Applicants' method determines that the loan officer access permissions do not permit the loan officer to access the specified database field, then Applicants' method denies the loan officer's access request.

In step 26, Applicants' method defines appraiser access permissions for each of the plurality of database fields. If the financial institution or the buyer engages the services of an appraiser, and if that appraiser requests access to a specified database field, Applicants' method determines if the appraiser access permissions permit the appraiser to access the specified database field. If Applicants' method determines that the appraiser access permissions permit the appraiser to access the specified database field, then Applicants' method grants the appraiser's access request. If Applicants' method determines that the appraiser access permissions do not permit the appraiser to access the specified database field, then Applicants' method denies the appraiser's access request. Applicants' loan tracking method transitions from step 26 to step 50.

If Applicants' method determines in step 14 to generate and maintain a hard copy file for the new real estate transaction of step 12, then Applicants' loan tracking method also includes steps 30, 32, 34, 36, 38, and 40. In step 30, Applicants' method assigns a machine-readable code to an outside portion of the hard copy file. In certain embodiments, the machine-readable code of step 30 comprises a bar code.

In step 32, Applicants' method determines whether to use a wireless tracking device. If Applicants' method elects in step 32 to use a wireless tracking device, then in step 34 the method attaches a wireless tracking device to the hard copy file. Applicants' method transitions from step 34 to step 36.

In certain embodiments, the wireless tracking device of step 30 comprises an RFID tag. In certain embodiments, the wireless tracking device of step 30 comprises a wireless transmitting device such as those used with the LOJACK tracking system. In certain embodiments, the wireless tracking device of step 30 comprises a GPS device such as those used in the ON STAR tracking system.

If Applicants' method elects in step 32 not to use a wireless tracking device, then the method transitions from step 32 to step 36 wherein the method provides one of the data input devices of step 10 to each person that will, at some time, receive the hard copy file. In certain embodiments, each person receiving the hard copy file is assigned a unique personal identifier

The data input device of step 36 is capable of reading the machine readable code of step 30. In certain embodiments, the data input device of step 36 comprises a bar code reader, wherein that bar code reader is in communication with the server of step 10.

In step 38, every time possession of the hard copy file is transferred, the transferee causes an assigned data input device to read the machine readable code of step 30, and that data input device provides the date, time, file identifier, and the personal identifier assigned to the transferee. For example, if at a first time possession of the hard copy file is transferred from a first person to a second person, wherein that second person is assigned a second personal identifier, in step 38 the data input device assigned to the second person reads the machine-readable label affixed to the hard copy file, and provides to the server the first time, the file identifier encoded in that machine-readable code, and the second personal identifier.

In step 40, Applicants' method maintains in the new database entry of step 18 a log of every scanner signal received, wherein that signal comprises the file identifier assigned in step 30 to the hard copy file of step 14, the time that signal was received, and the personal identifier assigned to the person sending the signal. Applicants' method transitions from step 40 to step 50 (FIG. 1D).

Referring now to FIG. 1D, in step 50 Applicants' method monitors the database fields associated with the new database entry of step 18 to determine, inter alia, if an action time has been missed. If Applicants' method determines in step 50 that no action times have been missed, then the method transitions from step 50 to step 54. Alternatively, if the method determines in step 50 that an action time has been missed, then the method transitions from step 50 to step 52 wherein the method provides a status message to the contact alert associated in the database with the missed action time. In certain embodiments, the status message of step 52 comprises an alert message that a processing step was not timely performed. In certain embodiments, the status message of step 52 further comprises a query asking if the hard copy file has been misplaced.

Applicants' method transitions from step 52 to step 54 wherein the method determines if the hard copy file has been misplaced. If Applicants' method determines in step 54 that the hard copy file has not been misplaced, then the method transitions from step 54 to step 50 and continues as described herein.

Alternatively, if the method determines in step 54 that the hard copy file has been misplaced, then the method transitions from step 54 to step 56 wherein the method determines if a wireless tracking device is being used, i.e. if a wireless tracking device was placed on the file in step 34.

If Applicants' method determines in step 56 that a wireless tracking device is being used, then the method transitions from step 56 to step 58 wherein the method locates the hard copy file using the wireless tracking device attached to that file. Applicants' method transitions from step 58 to step 50 and continues as described herein.

Alternatively, if Applicants' method determines in step 56 that a wireless tracking device is not being used, then the method transitions from step 56 to step 60 wherein the method determines the last person to scan the machine-readable code affixed to the hard copy file. In step 62, Applicants' method provides a message to that last person to scan the machine-readable code affixed to the hard copy file requesting the location of the misplaced file. Applicants' method transitions from step 62 to step 50 and continues as described herein.

Referring now to FIGS. 2A, 3A, 4A, 5A, 6A, 7A, 8A, 9A, and 10A, recite individual steps of Applicants' transaction processing method. Referring now to FIG. 2A, FIG. 2A shows transaction processing steps 200, 205, 210, 215, 220, 230, 240, 245, 250, 255, 260, 265, 270, 275, 280, 285, and 290.

Referring now to FIG. 2B, FIG. 2B recites database fields 200a, 205a, 210a, 220a, 230a, 240a, 245a, 250a, 265a, 270a, 275a, 280a, and 285a, wherein those database fields comprises a portion of database fields 124. Each of the database fields recited in FIG. 2B corresponds to a method step recited in FIG. 2A. For example, database field 200a, comprising bibliographic data, comprises the data associated with step 200.

Each database field recited in FIG. 2B further comprises a descriptor attribute 272, access permissions attributes 274, data 276, a date/time stamp 278 comprising the date and time data 276 was initially input or subsequently revised, an action date/time attribute 280 comprising the date and time by which some subsequent action must be taken, a contact person attribute 282 comprising the person delegated to perform the required subsequent action, and a contact alert attribute comprising the person to be contacted in the event the subsequent action is not performed on or more before the action date/time attribute 280.

Access permissions are separately assigned to each attribute in each database field for a plurality of persons associated with the real property transaction. Using Applicants' method, the persons associated with a real property transaction include one or more BUYERS, one or more BROKERS, one or more LOAN OFFICERS, and one or more APPRAISERS. As a general matter, access permissions are defined as NONE wherein the person cannot read that attribute, READ wherein that person can read the attribute, and REVISE wherein the person can modify the attribute. In certain embodiments, access permissions are implemented by use of unique passwords. In certain embodiments, access permissions are implemented using retinal scans. In certain embodiments, access permissions are implemented using fingerprint reading and recognition.

FIG. 2C recites the access permissions allocated to the one or more BUYERS with respect to database fields 200a, 205a, 210a, 220a, 230a, 240a, 245a, 250a, 265a, 270a, 275a, 280a, and 285a. For example looking at database field 200a, the one or more BUYERS have access permission to read but not revise the data recited in bibliographic data database field 200a. Those one or more BUYERS may not, however, read the date/time stamp attribute, the action/time attribute, the contact person attribute, or the contact alert attribute, portions of database field 200a.

FIG. 2D recites the access permissions allocated to the one or more BROKERS with respect to database fields 200a, 205a, 210a, 220a, 230a, 240a, 245a, 250a, 265a, 270a, 275a, 280a, and 285a. FIG. 2E recites the access permissions allocated to the one or more LOAN OFFICERS with respect to database fields 200a, 205a, 210a, 220a, 230a, 240a, 245a, 250a, 265a, 270a, 275a, 280a, and 285a. FIG. 2F recites the access permissions allocated to the one or more APPRAISERS with respect to database fields 200a, 205a, 210a, 220a, 230a, 240a, 245a, 250a, 265a, 270a, 275a, 280a, and 285a.

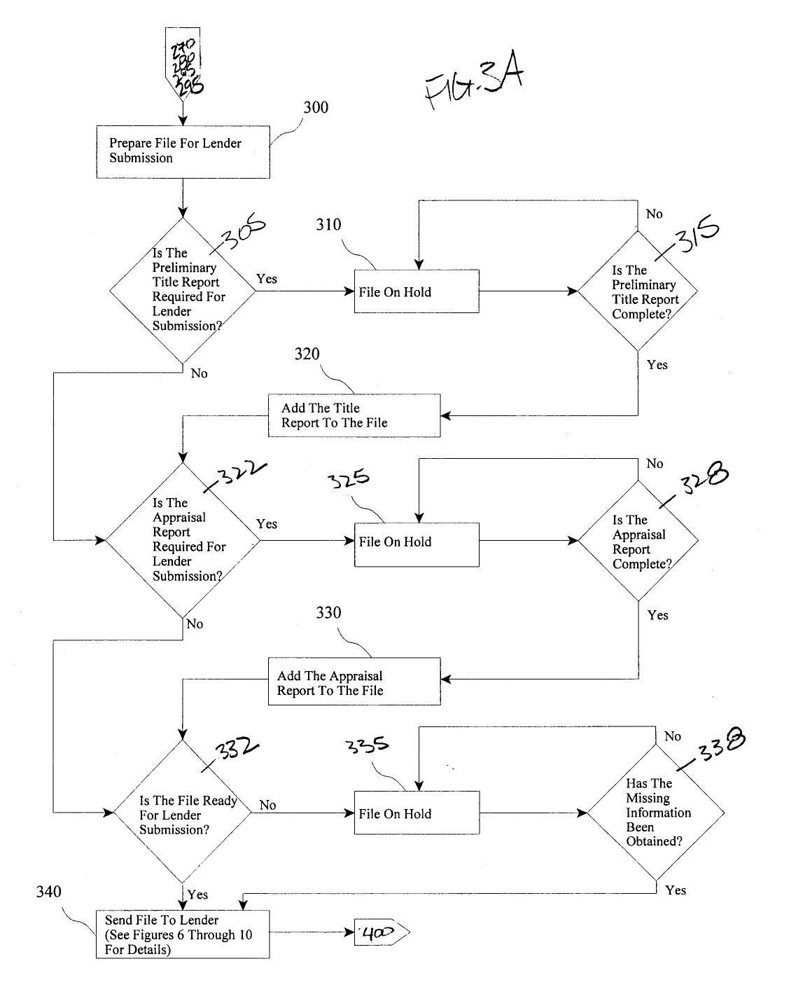

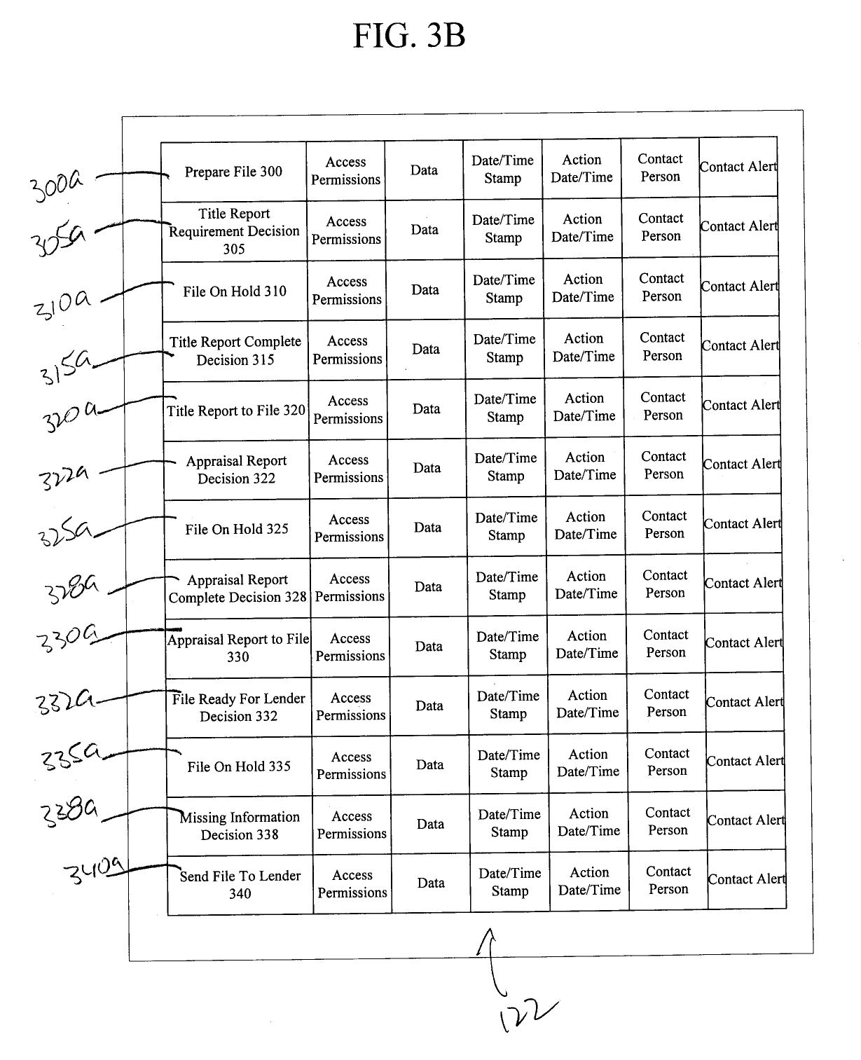

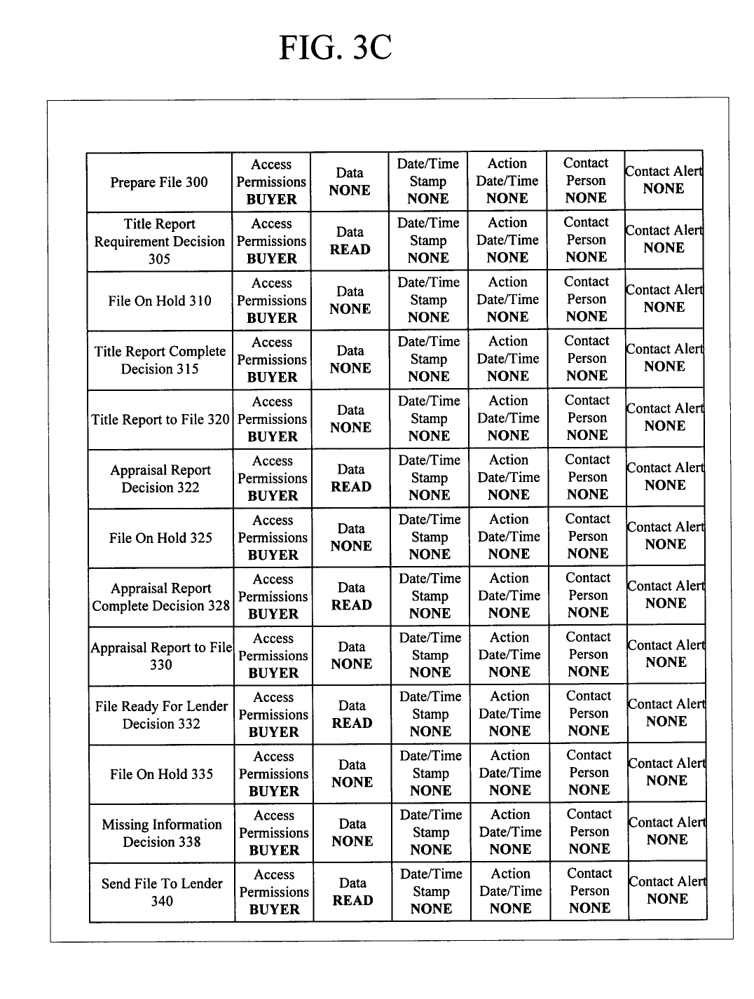

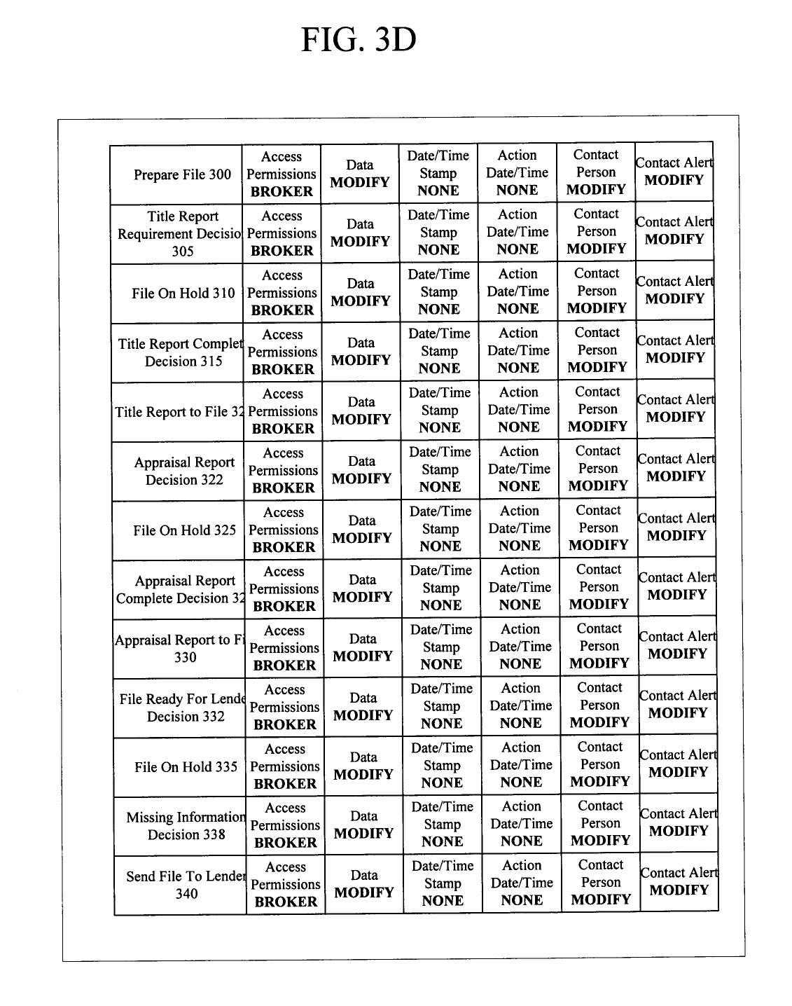

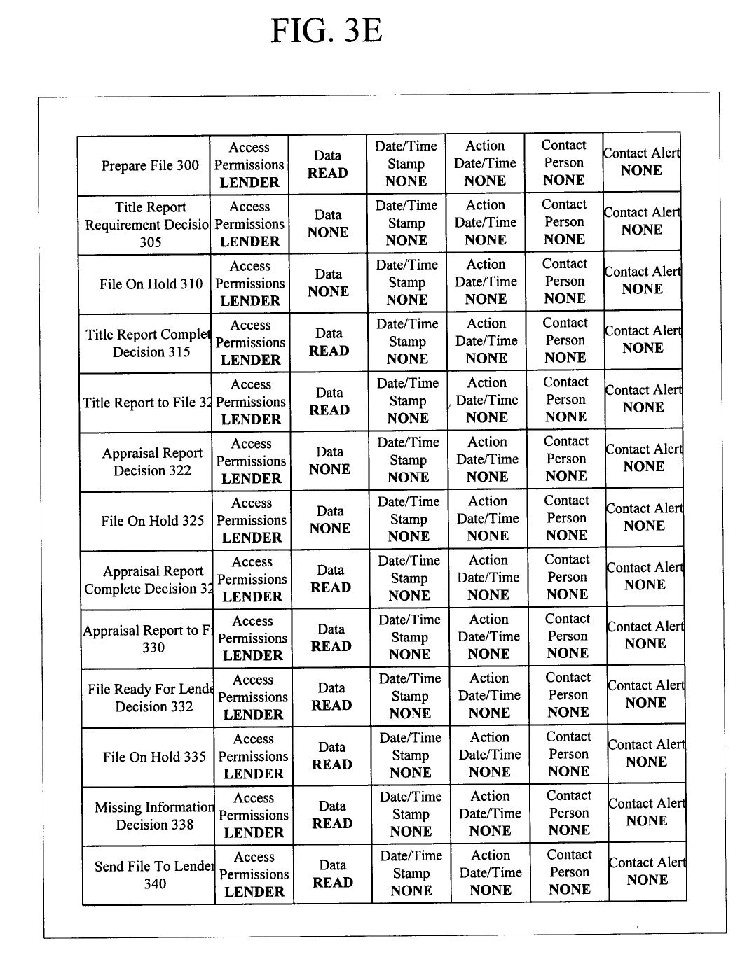

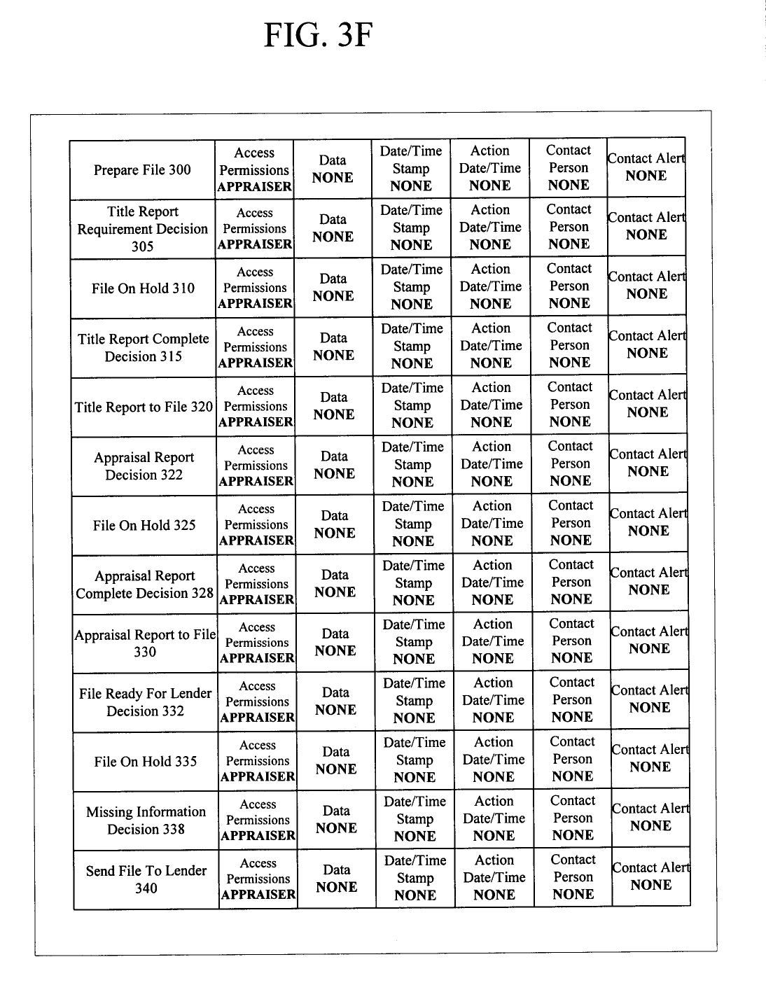

FIG. 3A shows transaction processing steps 300,305, 310, 315, 320, 322, 325, 328, 330, 332, 335, 338, and 340. FIG. 3B recites database fields 300a, 305a, 310a, 315a, 320a, 322a, 325a, 328a, 330a, 332a, 335a, 338a, and 340a, wherein those database fields comprises a portion of database fields 124. Each of the database fields recited in FIG. 2B corresponds to a method step recited in FIG. 2A.

FIG. 3C recites the access permissions allocated to the one or more BUYERS with respect to database fields 300a, 305a, 310a, 315a, 320a, 322a, 325a, 328a, 330a, 332a, 335a, 338a, and 340a. FIG. 3D recites the access permissions allocated to the one or more BROKERS with respect to database fields 300a, 305a, 310a, 315a, 320a, 322a, 325a, 328a, 330a, 332a, 335a, 338a, and 340a. FIG. 2E recites the access permissions allocated to the one or more LOAN OFFICERS with respect to database fields 300a, 305a, 310a, 315a, 320a, 322a, 325a, 328a, 330a, 332a, 335a, 338a, and 340a. FIG. 2F recites the access permissions allocated to the one or more APPRAISERS with respect to database fields 300a, 305a, 310a, 315a, 320a, 322a, 325a, 328a, 330a, 332a, 335a, 338a, and 340a.

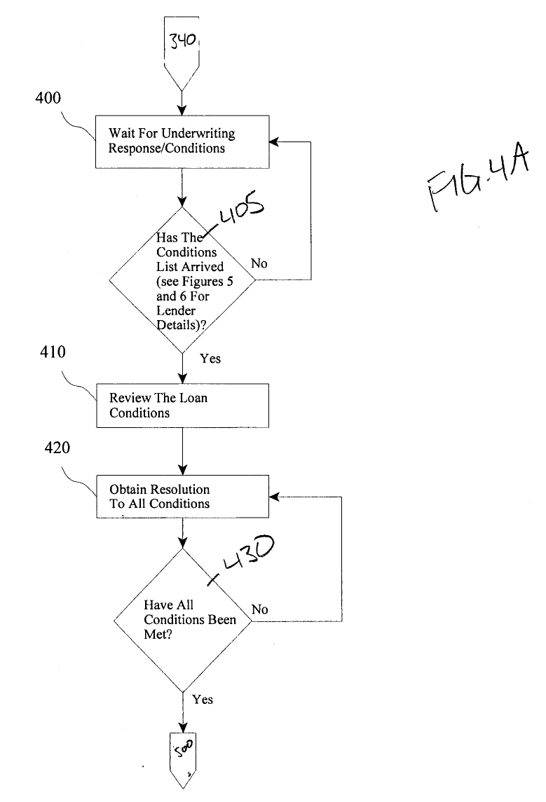

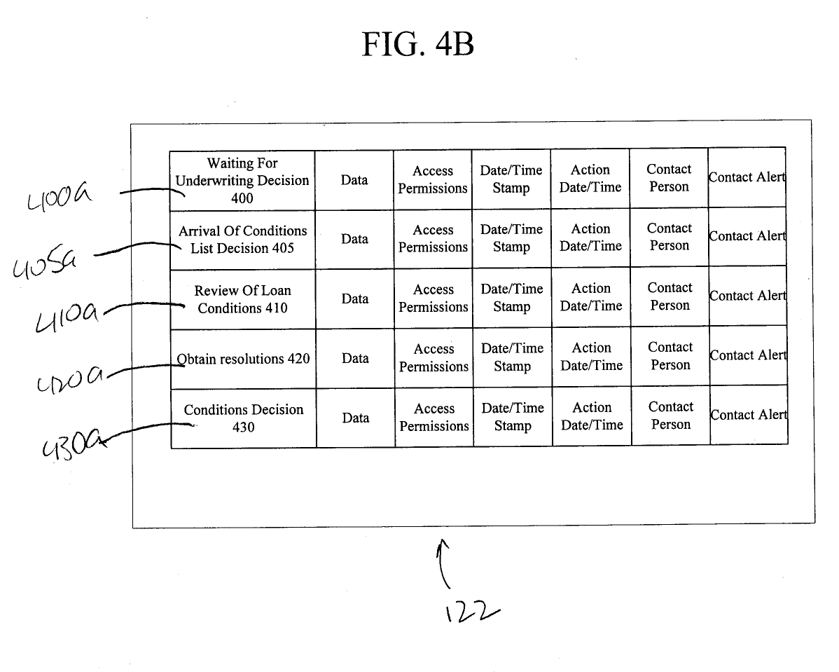

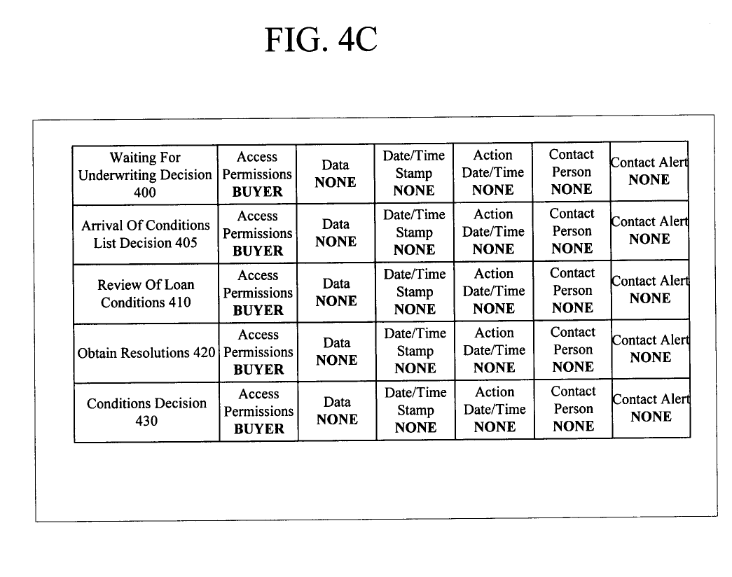

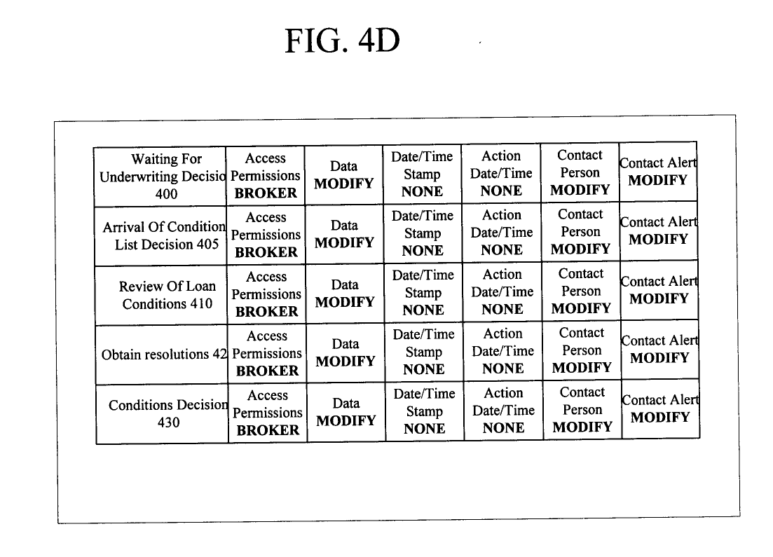

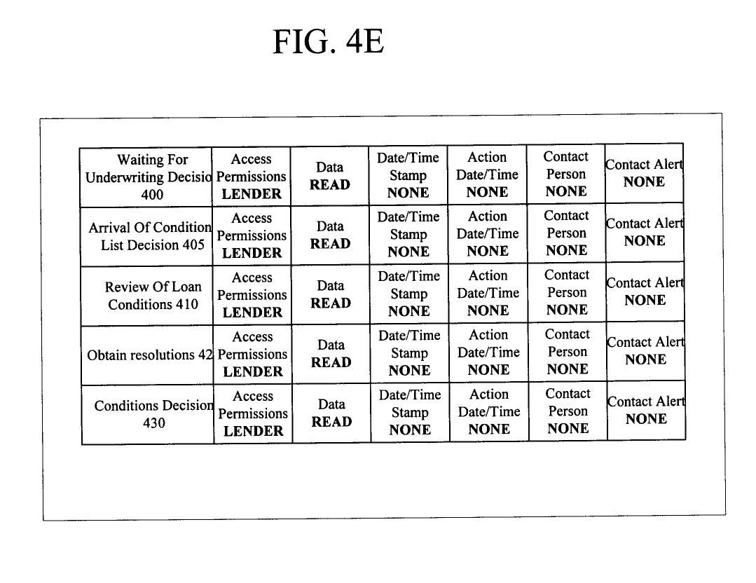

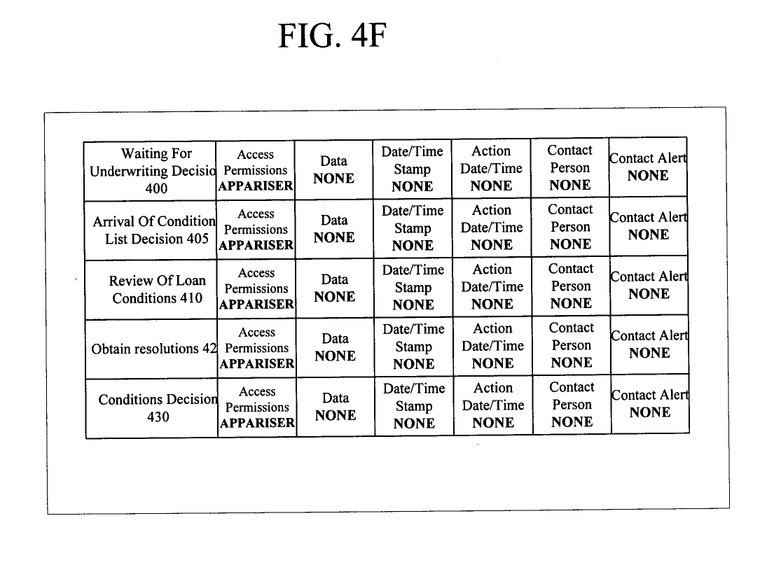

FIG. 4A shows transaction processing steps 400, 405, 410, 420, and 430. FIG. 4B recites database fields 400a, 405a, 410a, 420a, and 430a, wherein those database fields comprises a portion of database fields 124. Each of the database fields recited in FIG. 4B corresponds to a method step recited in FIG. 4A.

FIG. 4C recites the access permissions allocated to the one or more BUYERS with respect to database fields 400a, 405a, 410a, 420a, and 430a. FIG. 4D recites the access permissions allocated to the one or more BROKERS with respect to database fields 400a, 405a, 410a, 420a, and 430a. FIG. 4E recites the access permissions allocated to the one or more LOAN OFFICERS with respect to database fields 400a, 405a, 410a, 420a, and 430a. FIG. 4F recites the access permissions allocated to the one or more APPRAISERS with respect to database fields 400a, 405a, 410a, 420a, and 430a.

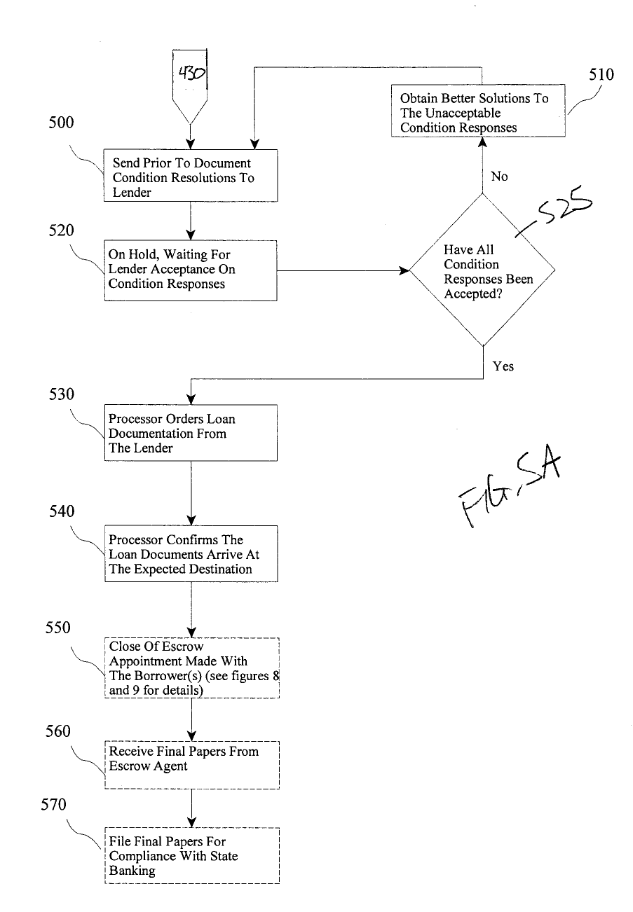

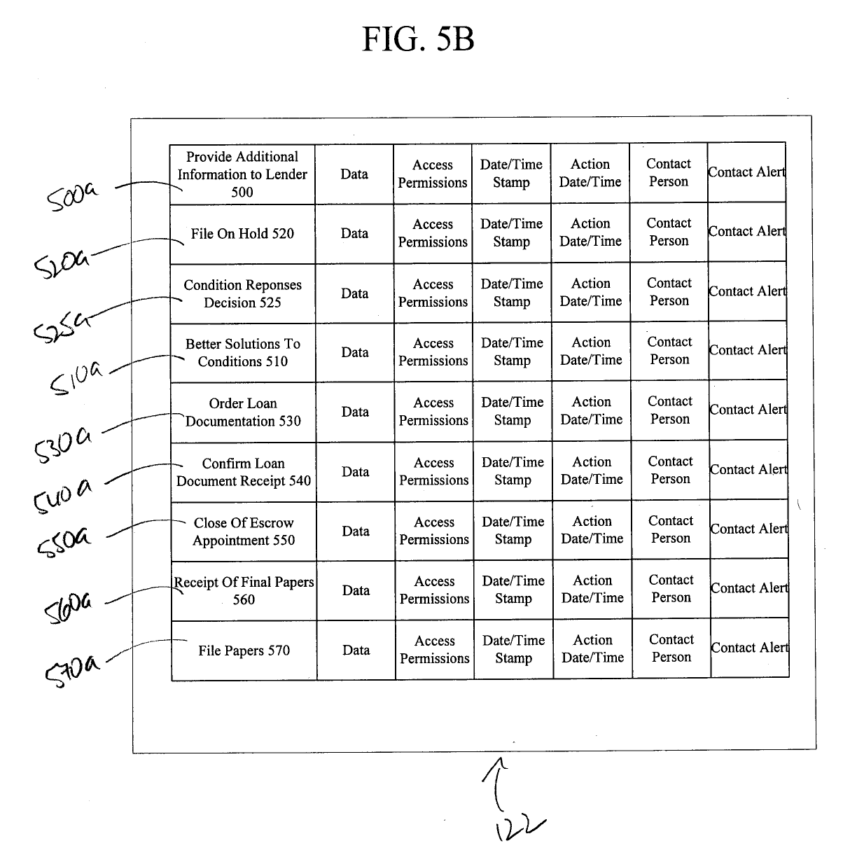

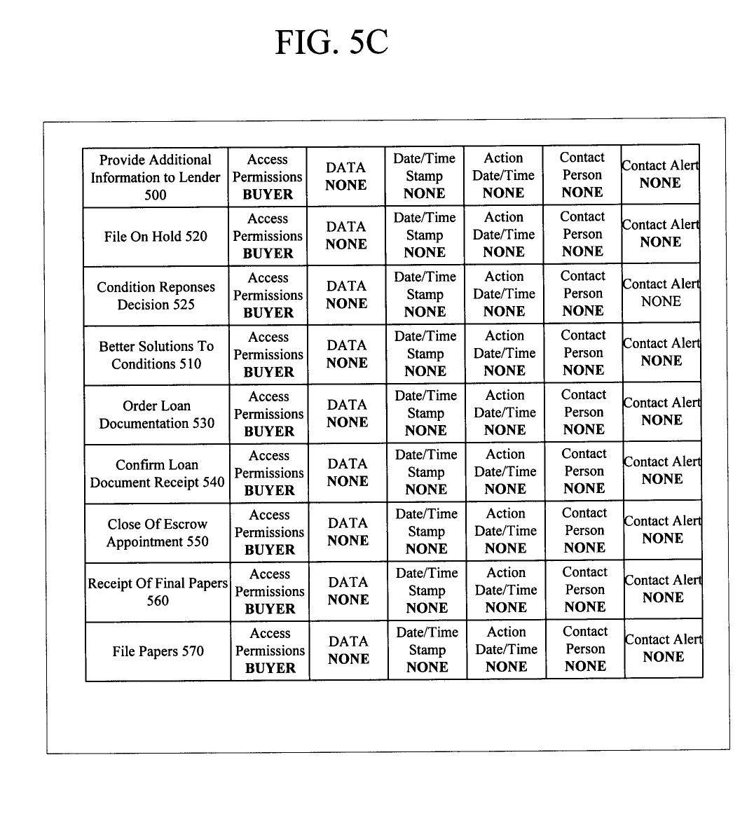

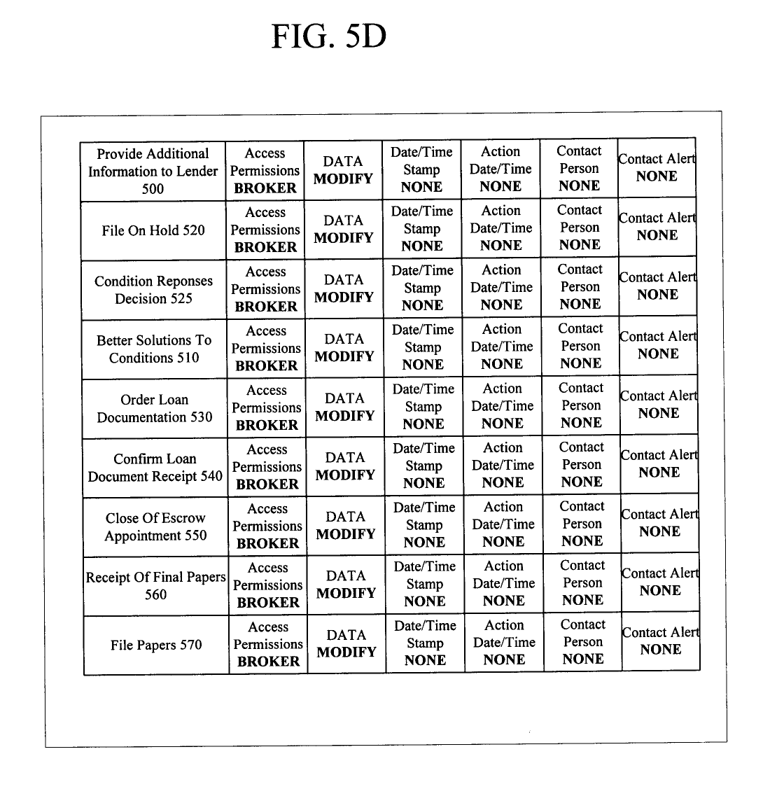

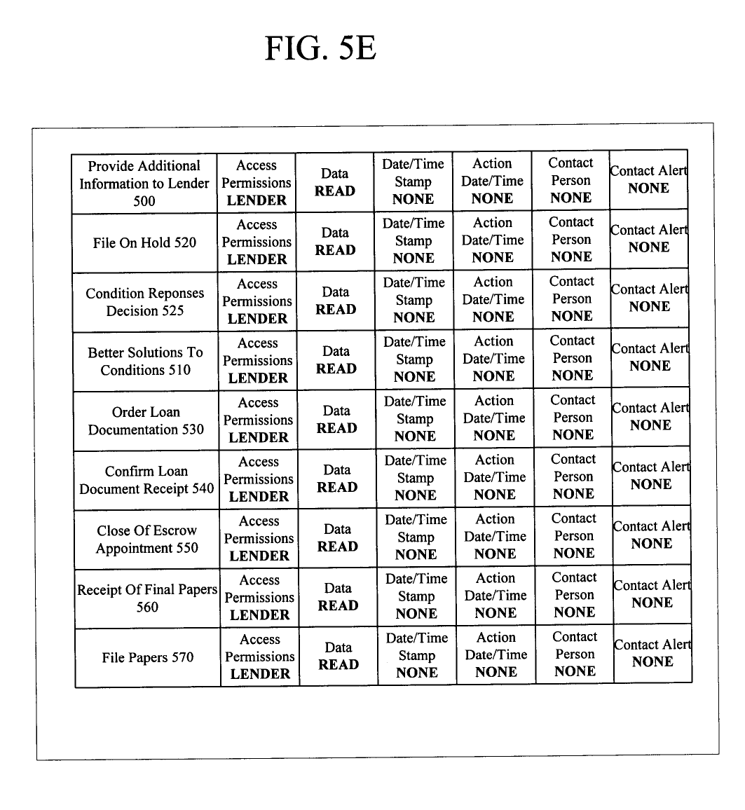

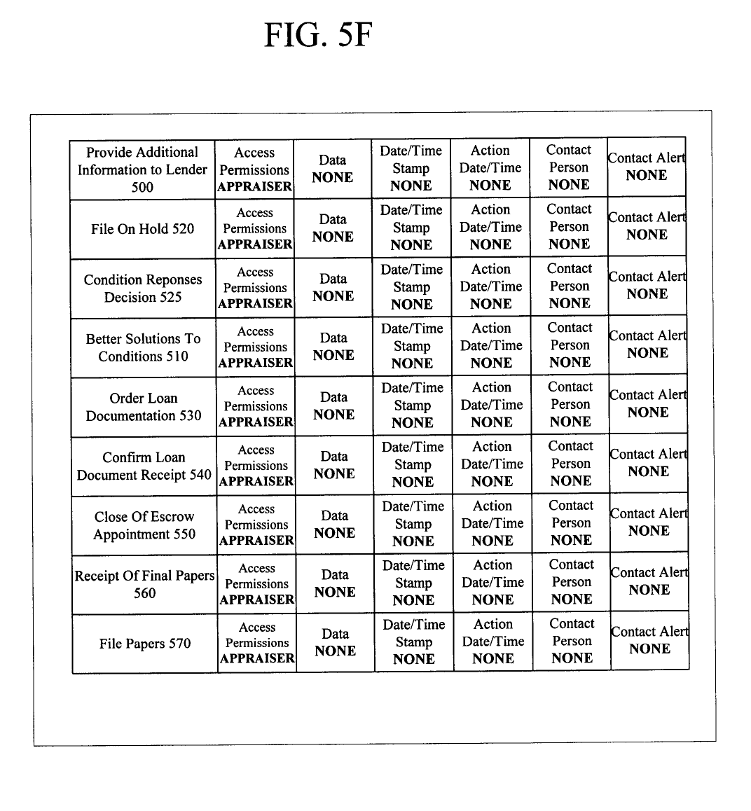

FIG. 5A shows transaction processing steps 500, 510, 520, 525, 530, 540, 550, 560, and 570. FIG. 4B recites database fields 500a, 510a, 520a, 525a, 530a, 540a, 550a, 560a, and 570a, wherein those database fields comprises a portion of database fields 124. Each of the database fields recited in FIG. 5B corresponds to a method step recited in FIG. 5A.

FIG. 5C recites the access permissions allocated to the one or more BUYERS with respect to database fields 500a, 510a, 520a, 525a, 530a, 540a, 550a, 560a, and 570a. FIG. 5D recites the access permissions allocated to the one or more BROKERS with respect to database fields 500a, 510a, 520a, 525a, 530a, 540a, 550a, 560a, and 570a. FIG. 5E recites the access permissions allocated to the one or more LOAN OFFICERS with respect to database fields 500a, 510a, 520a, 525a, 530a, 540a, 550a, 560a, and 570a. FIG. 5F recites the access permissions allocated to the one or more APPRAISERS with respect to database fields 500a, 510a, 520a, 525a, 530a, 540a, 550a, 560a, and 570a.

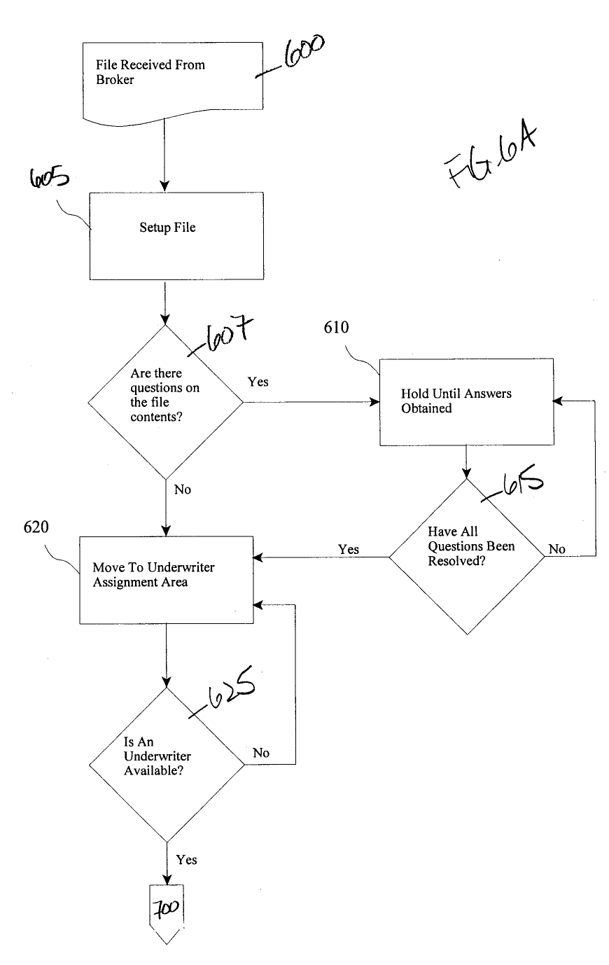

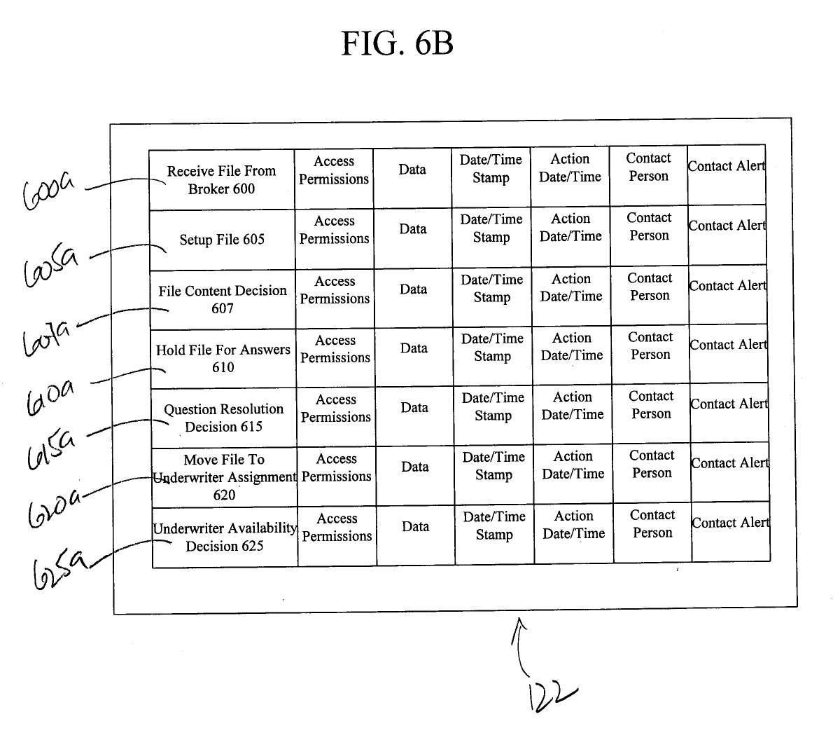

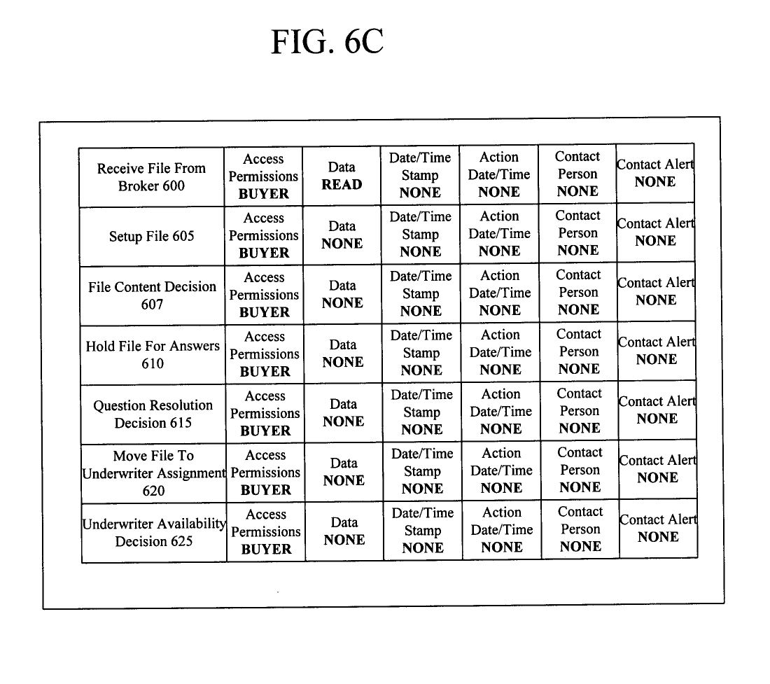

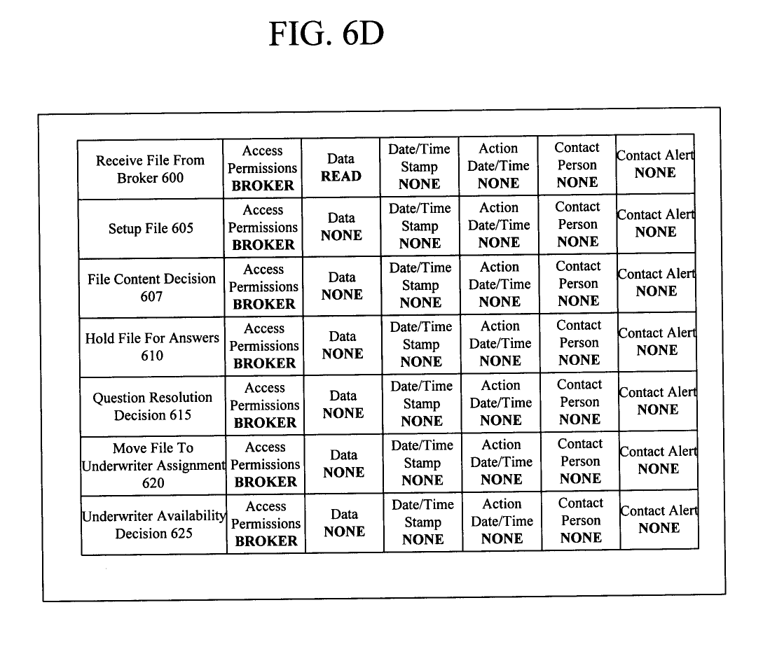

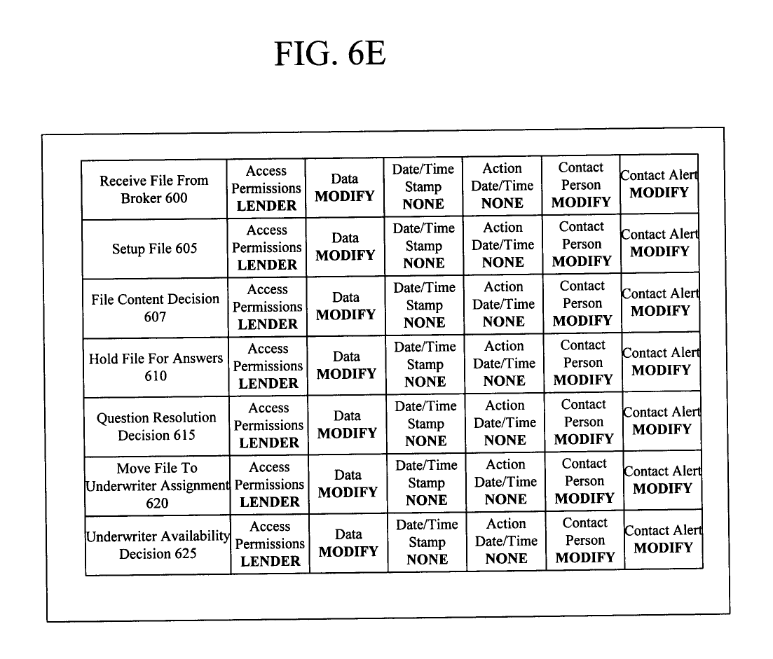

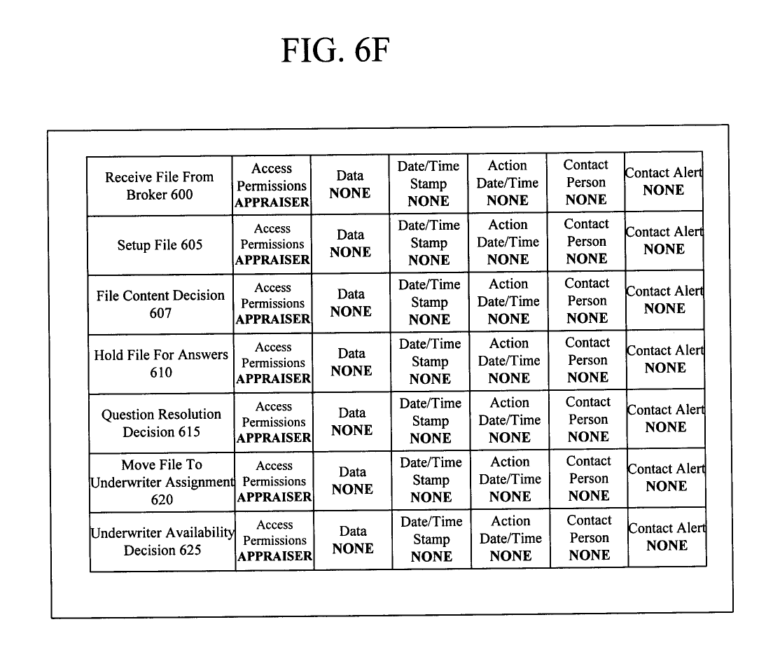

FIG. 6A shows transaction processing steps 600, 605, 610, 607, 610, 615, 620, and 625. FIG. 4B recites database fields 600a, 605a, 610a, 607a, 610a, 615a, 620a, and 625a, wherein those database fields comprises a portion of database fields 124. Each of the database fields recited in FIG. 6B corresponds to a method step recited in FIG. 6A.

FIG. 6C recites the access permissions allocated to the one or more BUYERS with respect to database fields 600a, 605a, 610a, 607a, 610a, 615a, 620a, and 625a. FIG. 6D recites the access permissions allocated to the one or more BROKERS with respect to database fields 600a, 605a, 610a, 607a, 610a, 615a, 620a, and 625a. FIG. 6E recites the access permissions allocated to the one or more LOAN OFFICERS with respect to database fields 600a, 605a, 610a, 607a, 610a, 615a, 620a, and 625a. FIG. 6F recites the access permissions allocated to the one or more APPRAISERS with respect to database fields 600a, 605a, 610a, 607a, 610a, 615a, 620a, and 625a.

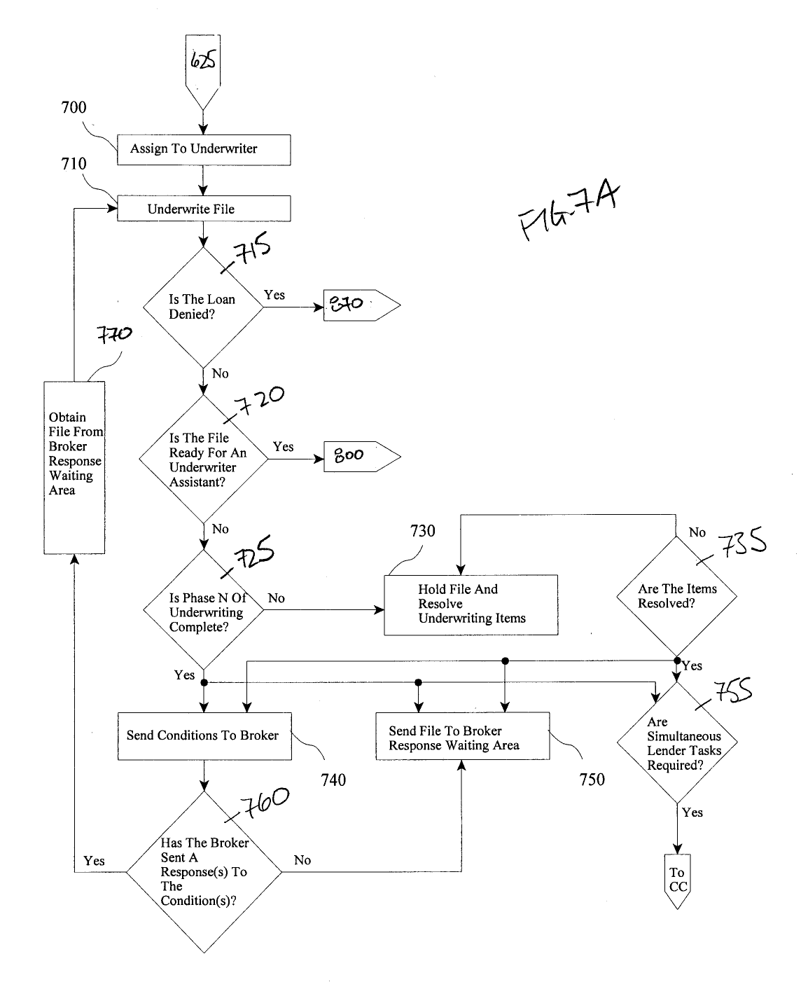

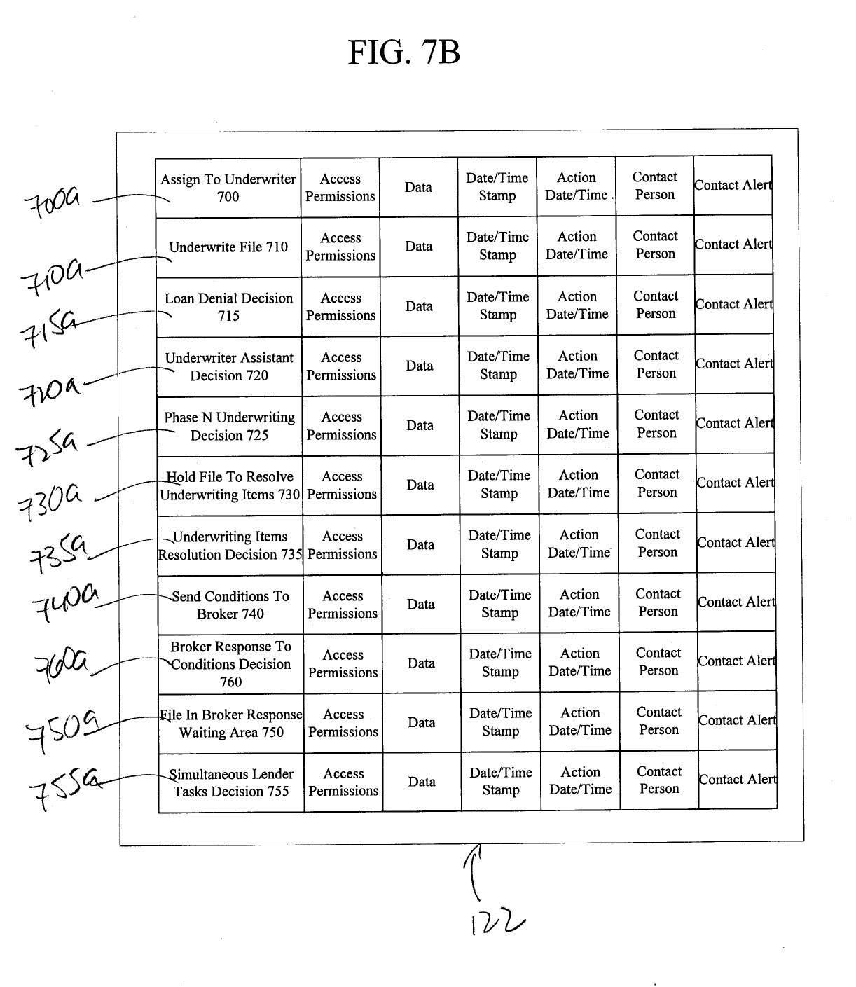

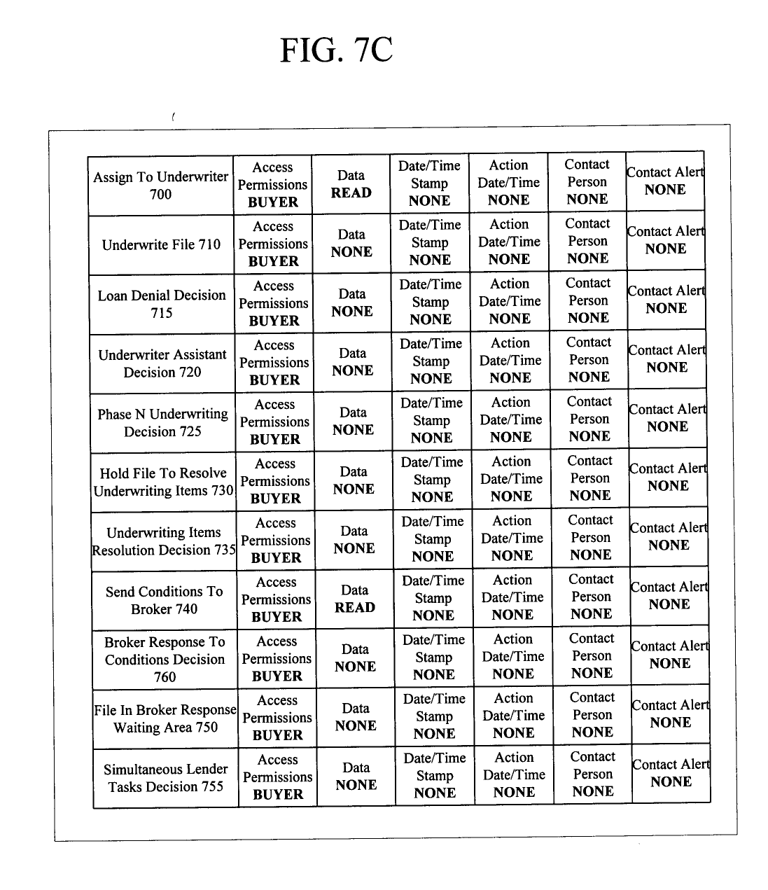

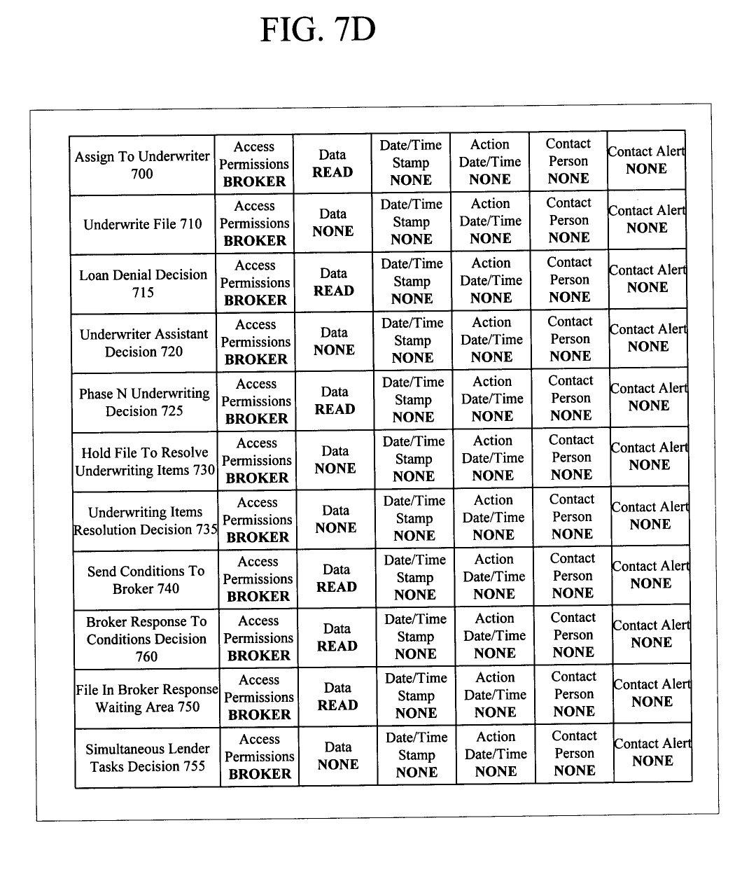

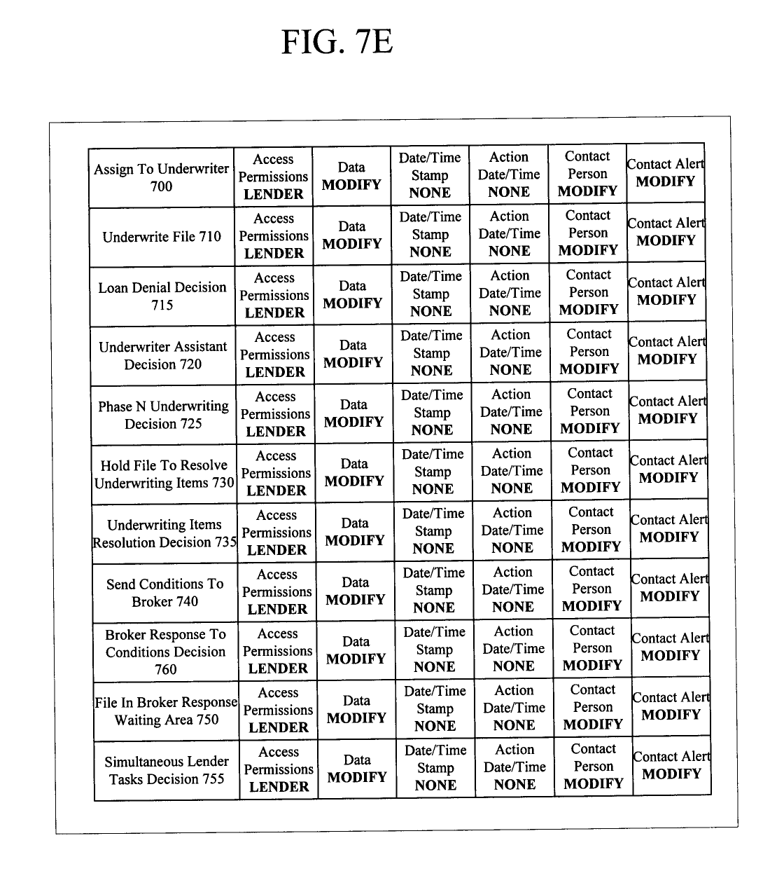

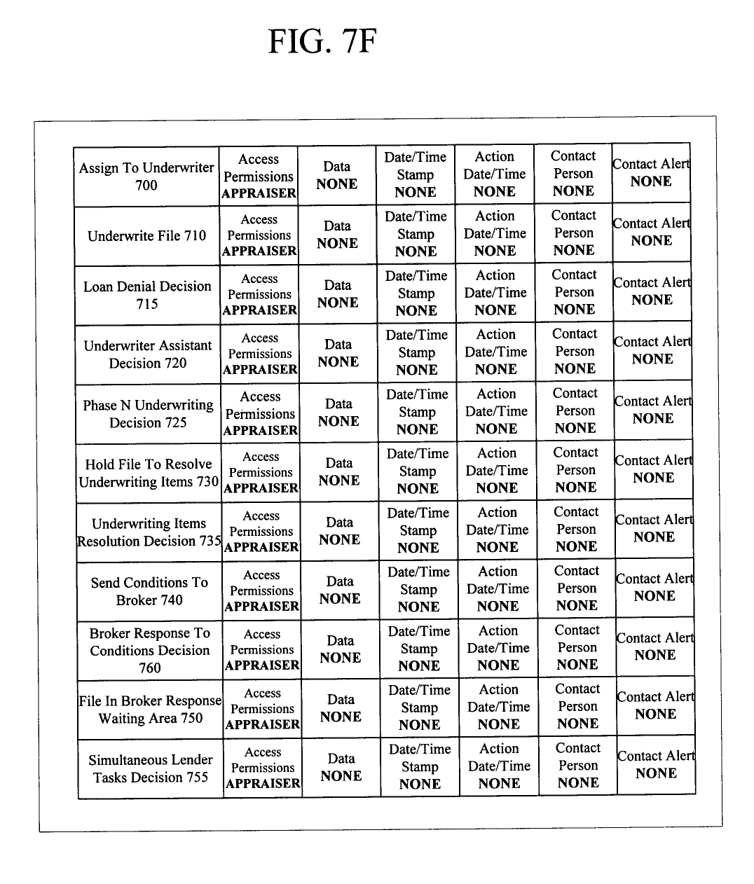

FIG. 7A shows transaction processing steps 700, 710, 715, 720, 725, 730, 735, 740, 750, 755, 760, and 770. FIG. 4B recites database fields 700a, 710a, 715a, 720a, 725a, 730a, 735a, 740a, 750a, 755a, 760a, and 770a, wherein those database fields comprises a portion of database fields 124. Each of the database fields recited in FIG. 7B corresponds to a method step recited in FIG. 7A.

FIG. 7C recites the access permissions allocated to the one or more BUYERS with respect to database fields 700a, 710a, 715a, 720a, 725a, 730a, 735a, 740a, 750a, 755a, 760a, and 770a. FIG. 7D recites the access permissions allocated to the one or more BROKERS with respect to database fields 700a, 710a, 715a, 720a, 725a, 730a, 735a, 740a, 750a, 755a, 760a, and 770a FIG. 7E recites the access permissions allocated to the one or more LOAN OFFICERS with respect to database fields 700a, 710a, 715a, 720a, 725a, 730a, 735a, 740a, 750a, 755a, 760a, and 770a. FIG. 7F recites the access permissions allocated to the one or more APPRAISERS with respect to database fields 700a, 710a 700a, 710a, 715a, 720a, 725a, 730a, 735a, 740a, 750a, 755a, 760a, and 770a.

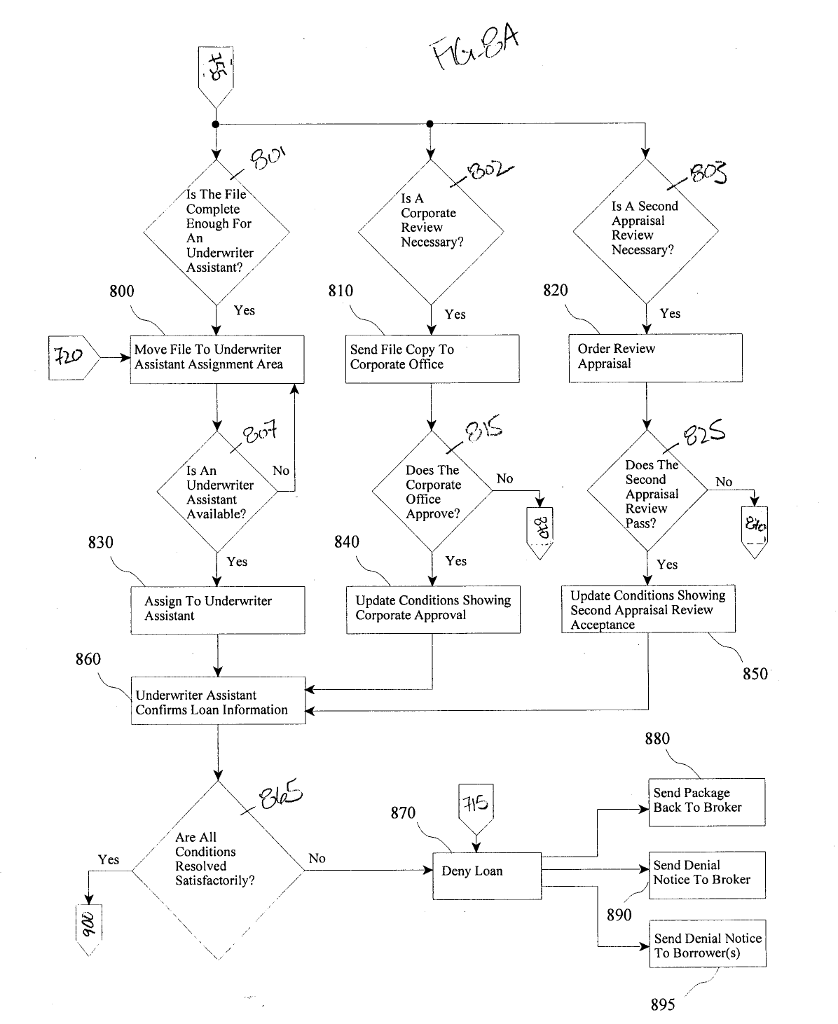

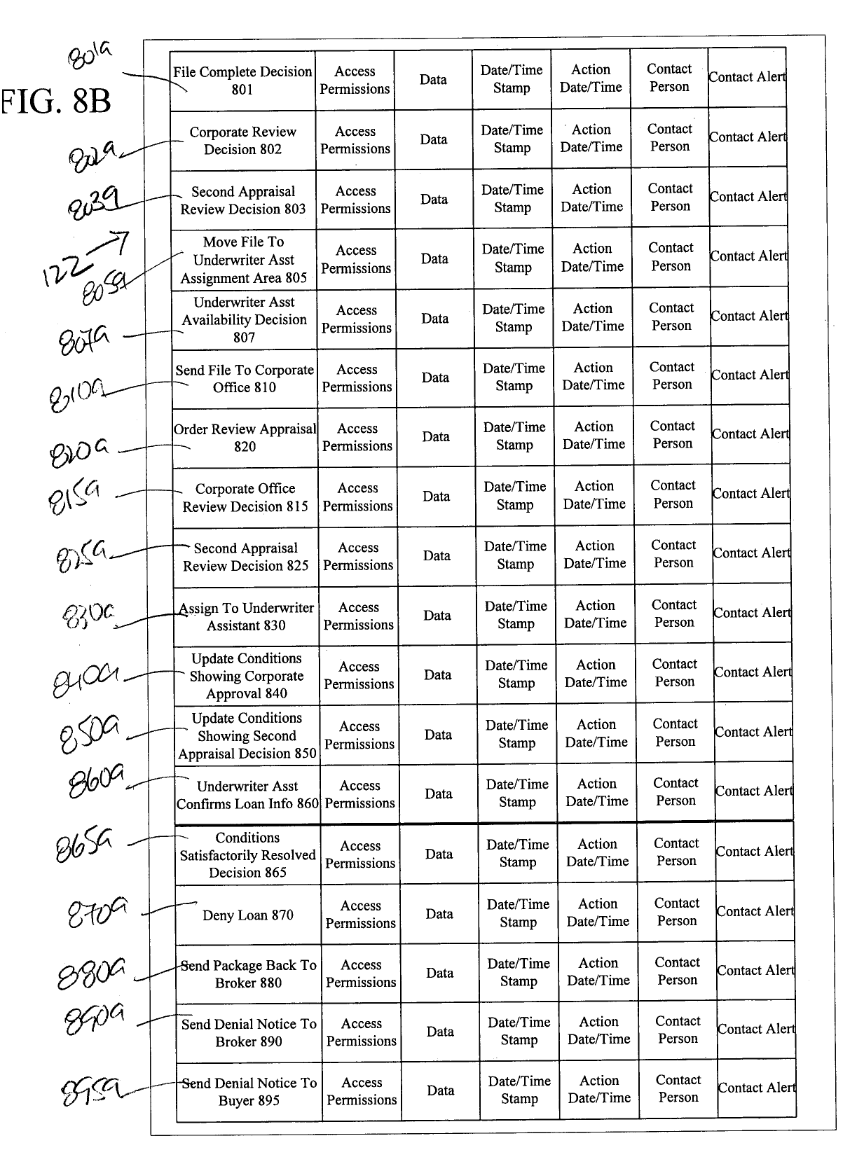

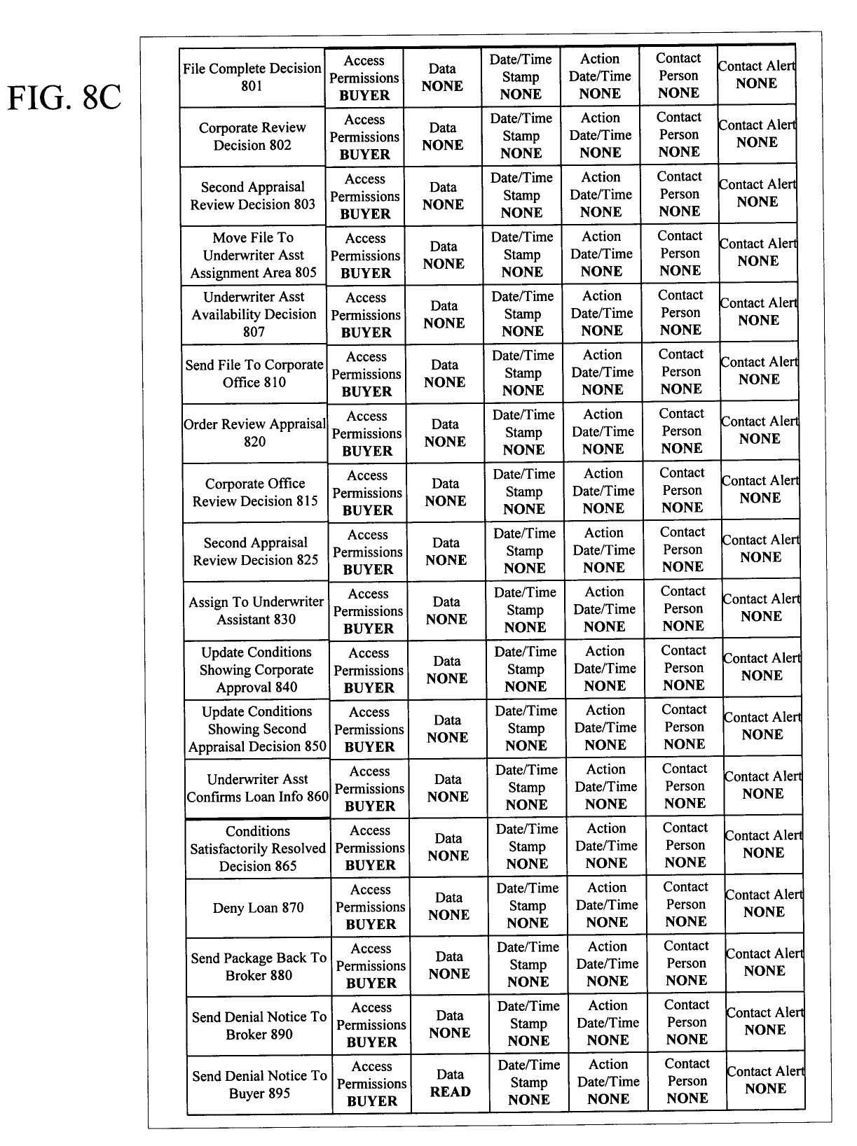

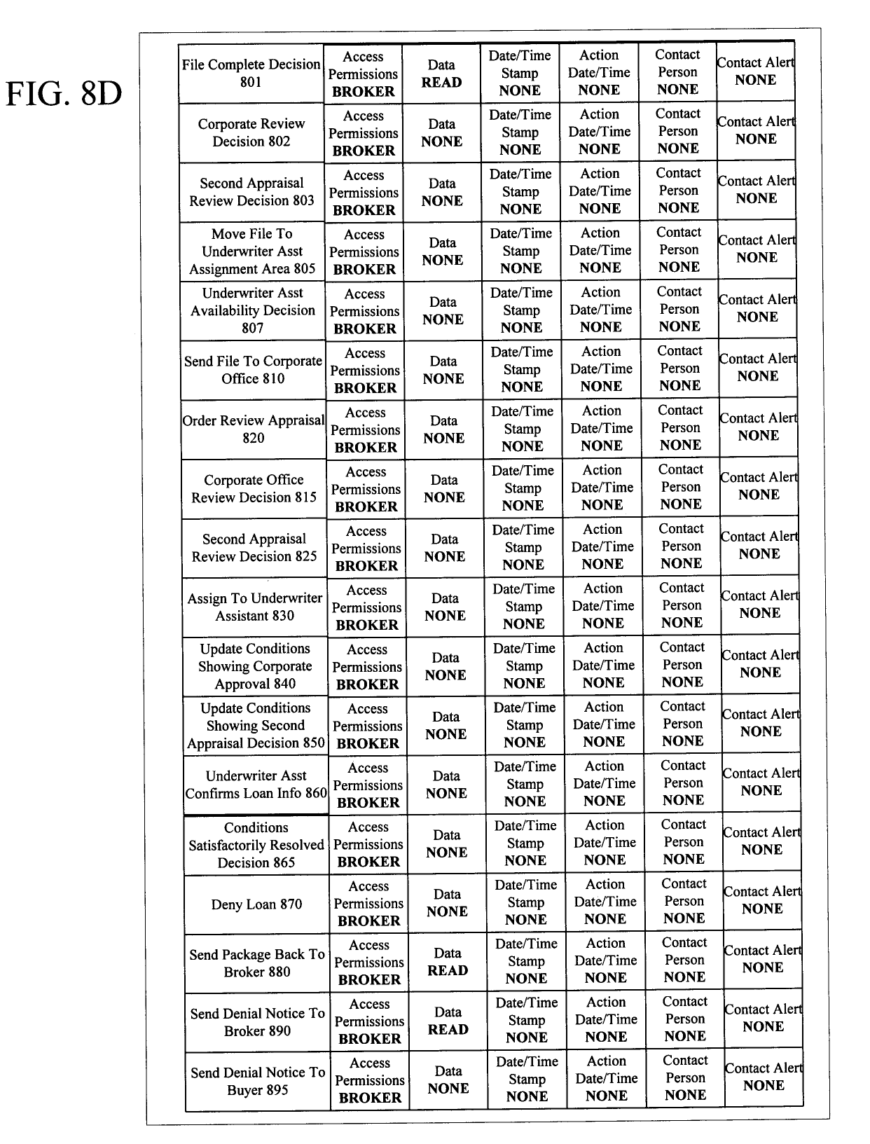

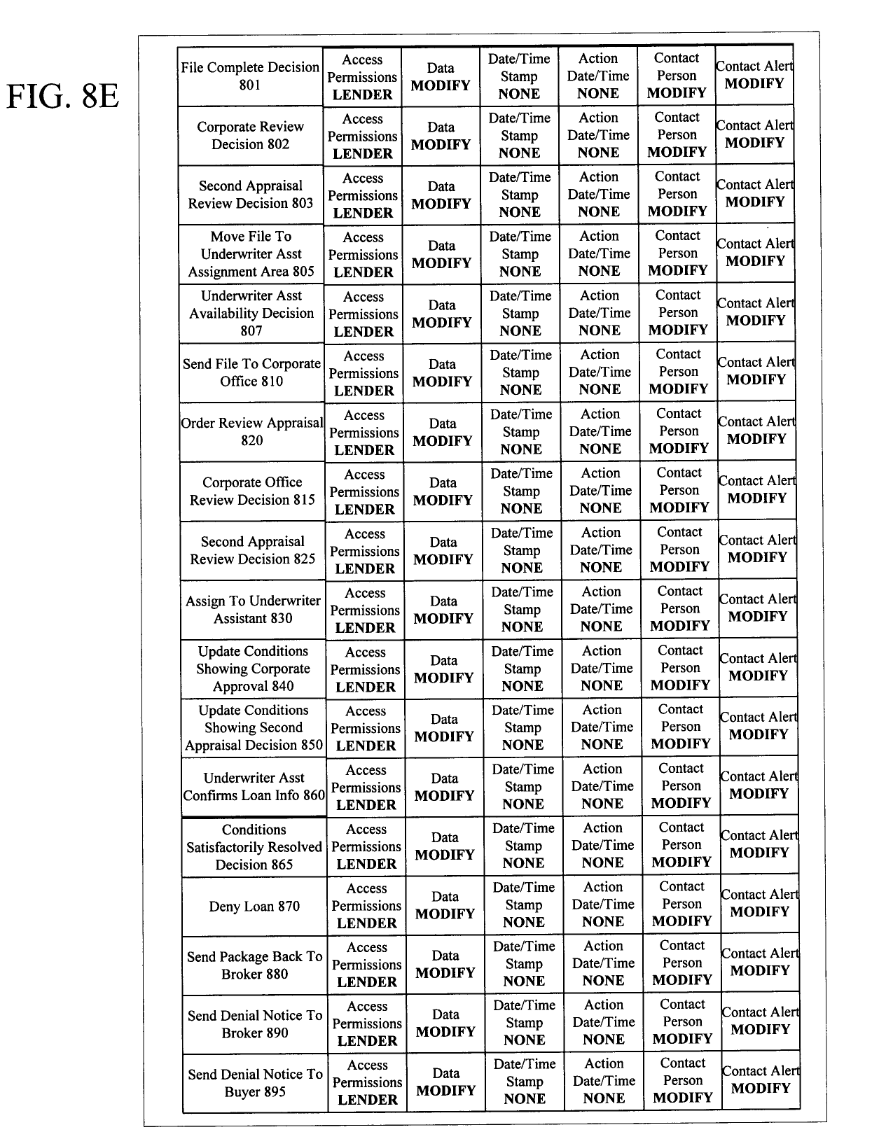

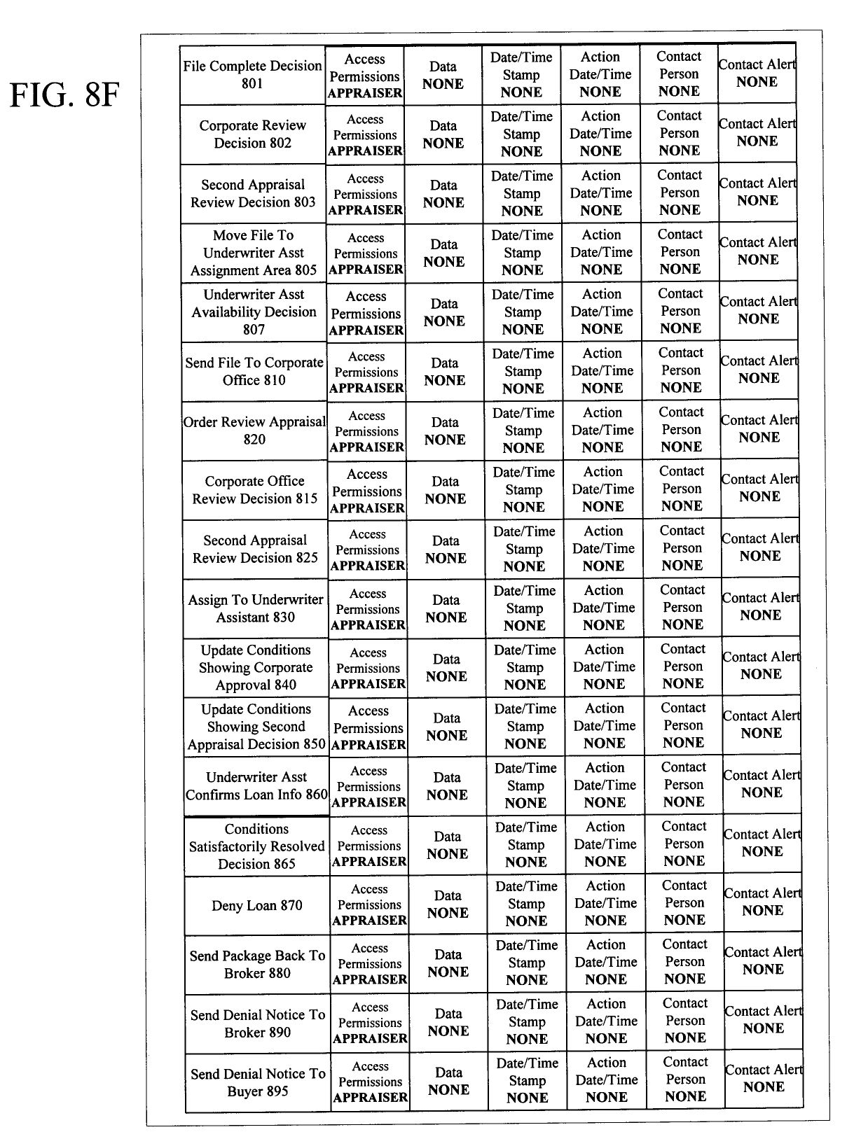

FIG. 8A shows transaction processing steps 800, 801, 802, 803, 807, 810, 815, 820, 825, 830, 840, 850, 860, 865, 870, 880, 890, and 895. FIG. 8B recites database fields 800a, 801a, 802a, 803a, 807a, 810a, 815a, 820a, 825a, 830a, 840a, 850a, 860a, 865a, 870a, 880a 890a, and 895a, wherein those database fields comprises a portion of database fields 124. Each of the database fields recited in FIG. 8B corresponds to a method step recited in FIG. 8A.

FIG. 8C recites the access permissions allocated to the one or more BUYERS with respect to database fields 800a, 801a, 802a, 803a, 807a, 810a, 815a, 820a, 825a, 830a, 840a, 850a, 860a, 865a, 870a, 880a 890a, and 895a. FIG. 8D recites the access permissions allocated to the one or more BROKERS with respect to database fields 800a, 801a, 802a, 803a, 807a, 810a, 815a, 820a, 825a, 830a, 840a, 850a, 860a, 865a, 870a, 880a 890a, and 895a. FIG. 8E recites the access permissions allocated to the one or more LOAN OFFICERS with respect to database fields 800a, 801a, 802a, 803a, 807a, 810a, 815a, 820a, 825a, 830a, 840a, 850a, 860a, 865a, 870a, 880a 890a, and 895a. FIG. 8F recites the access permissions allocated to the one or more APPRAISERS with respect to database fields 800a, 801a, 802a, 803a, 807a, 810a, 815a, 820a, 825a, 830a, 840a, 850a, 860a, 865a, 870a, 880a 890a, and 895a.

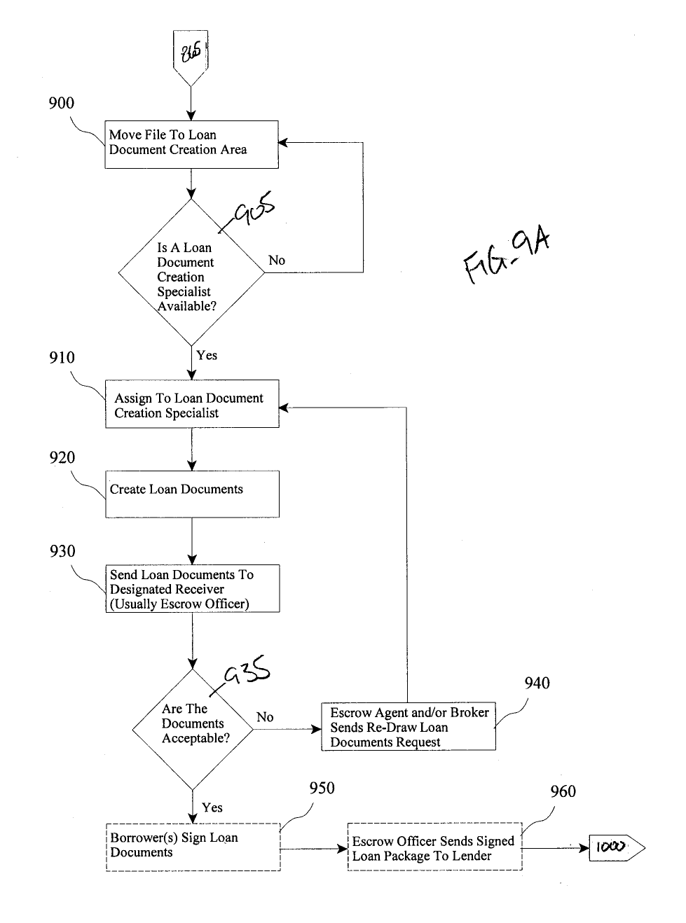

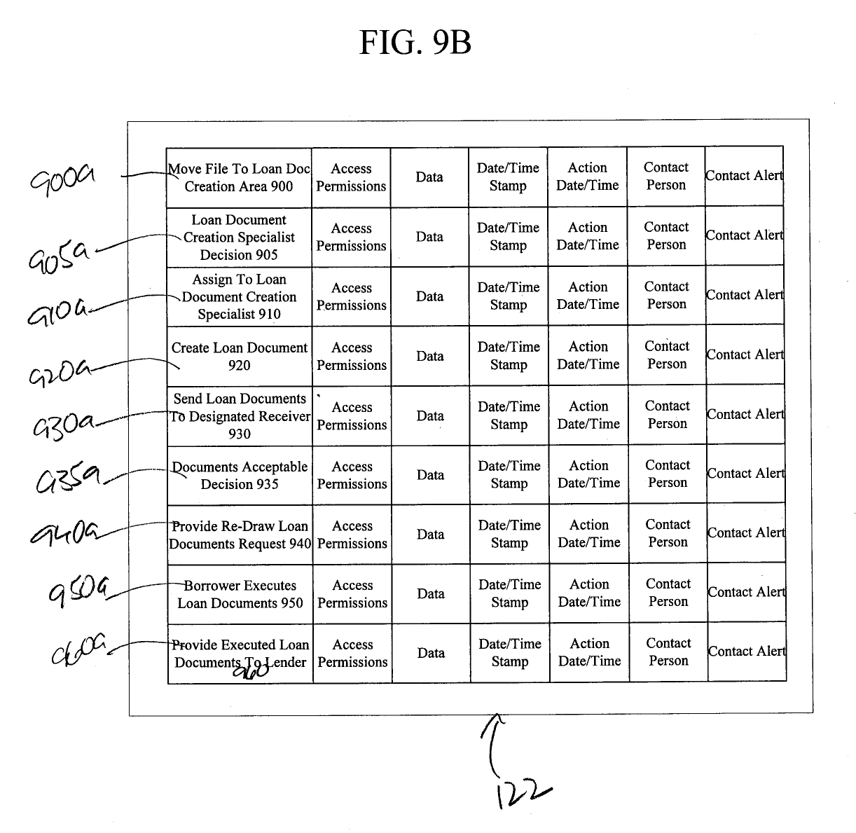

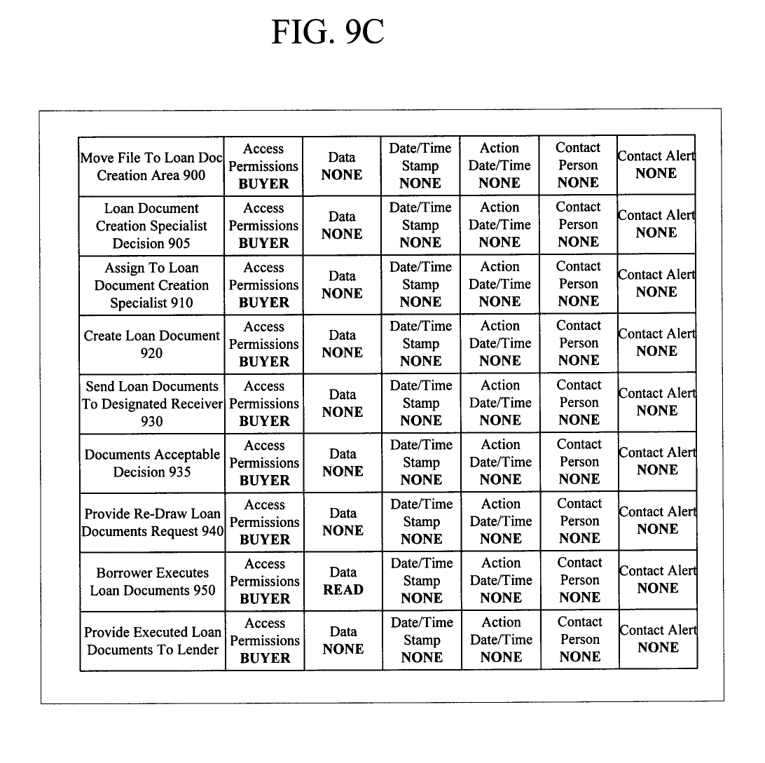

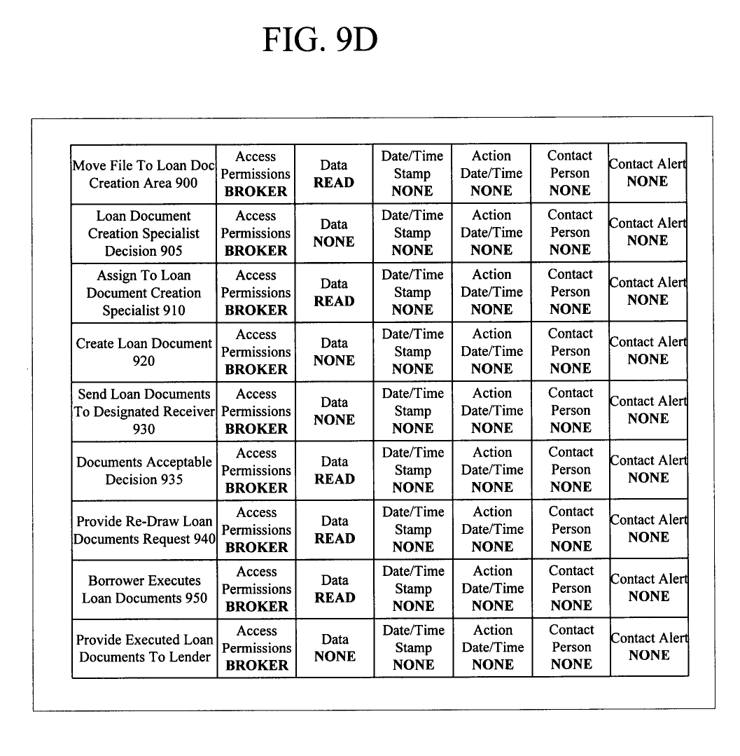

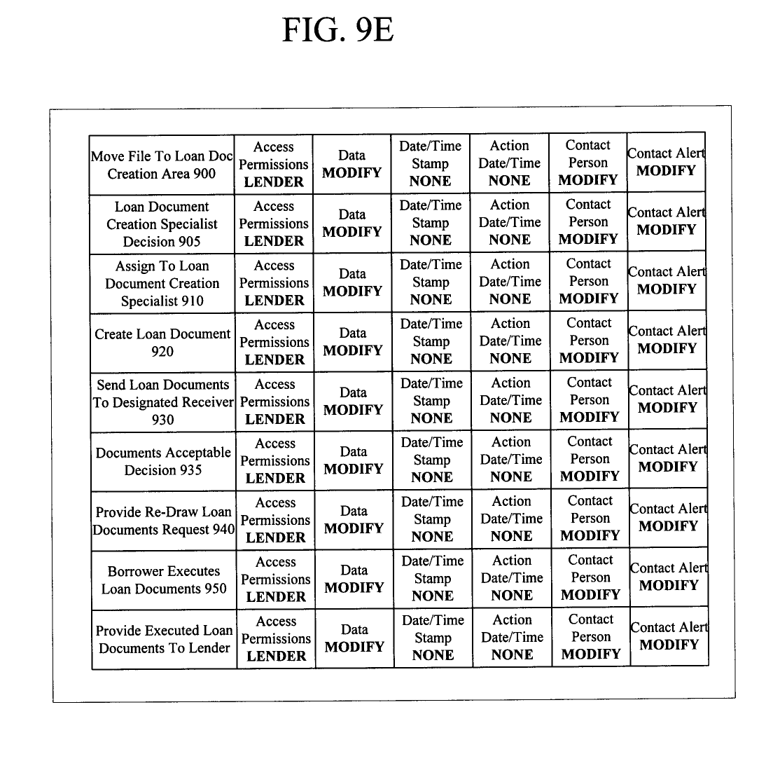

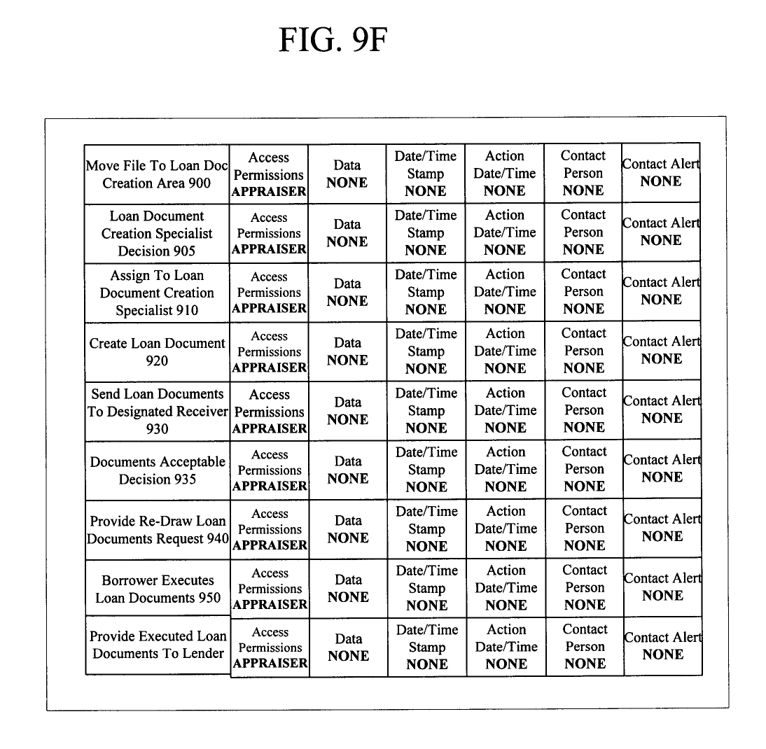

FIG. 9A shows transaction processing steps 900, 905, 910, 920, 930, 935, 940, 950, and 960. FIG. 9B recites database fields 900a, 905a, 910a, 920a, 930a, 935a, 940a, 950a, and 960a, wherein those database fields comprises a portion of database fields 124. Each of the database fields recited in FIG. 9B corresponds to a method step recited in FIG. 9A.

FIG. 9C recites the access permissions allocated to the one or more BUYERS with respect to database fields 900a, 905a, 910a, 920a, 930a, 935a, 940a, 950a, and 960a. FIG. 9D recites the access permissions allocated to the one or more BROKERS with respect to database fields 900a, 905a, 910a, 920a, 930a, 935a, 940a, 950a, and 960a. FIG. 9E recites the access permissions allocated to the one or more LOAN OFFICERS with respect to database fields 900a, 905a, 910a, 920a, 930a, 935a, 940a, 950a, and 960a. FIG. 9F recites the access permissions allocated to the one or more APPRAISERS with respect to database fields 900a, 905a, 910a, 920a, 930a, 935a, 940a, 950a, and 960a.

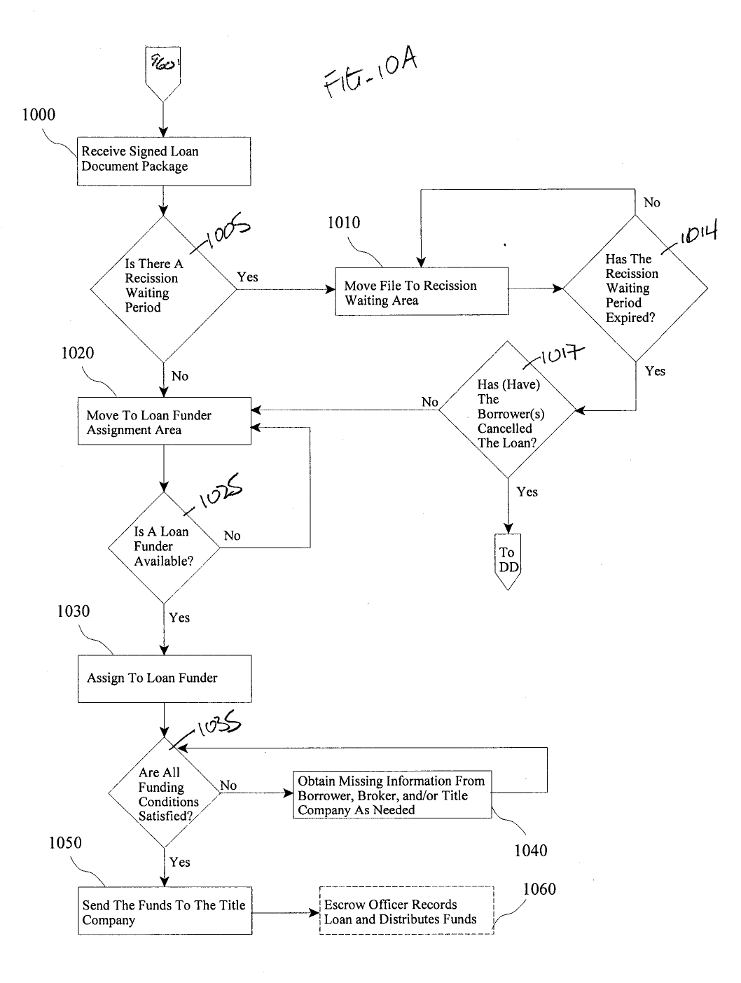

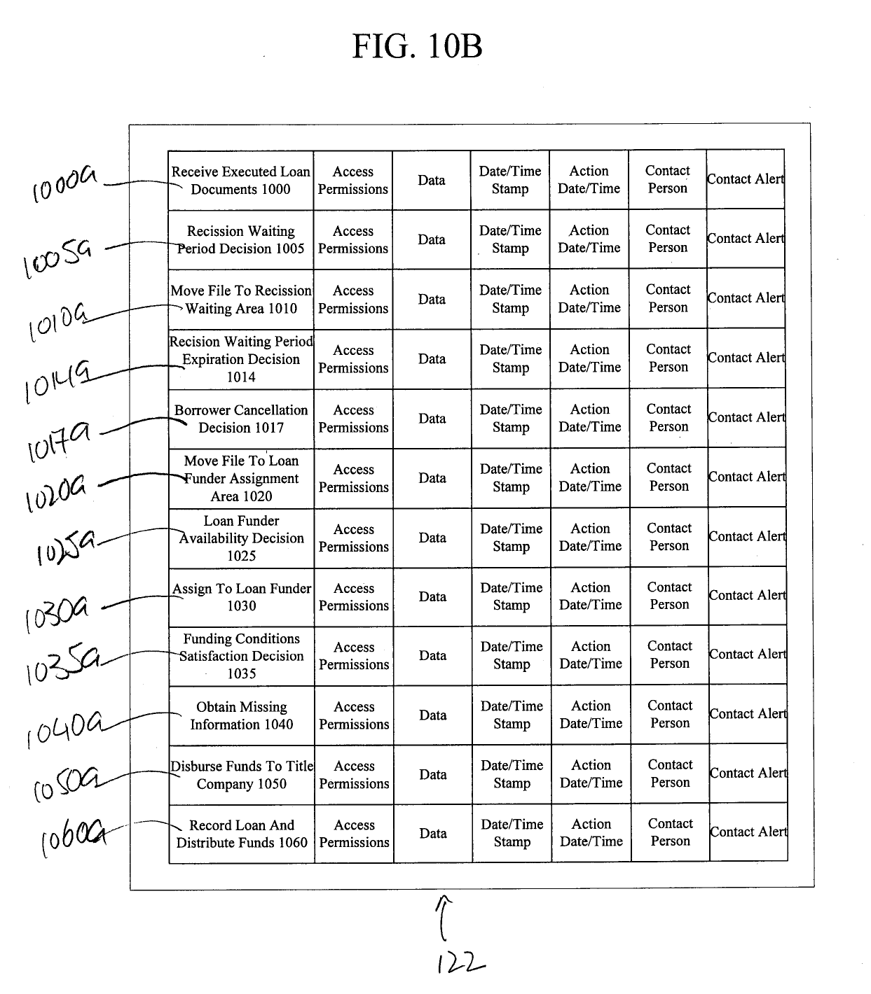

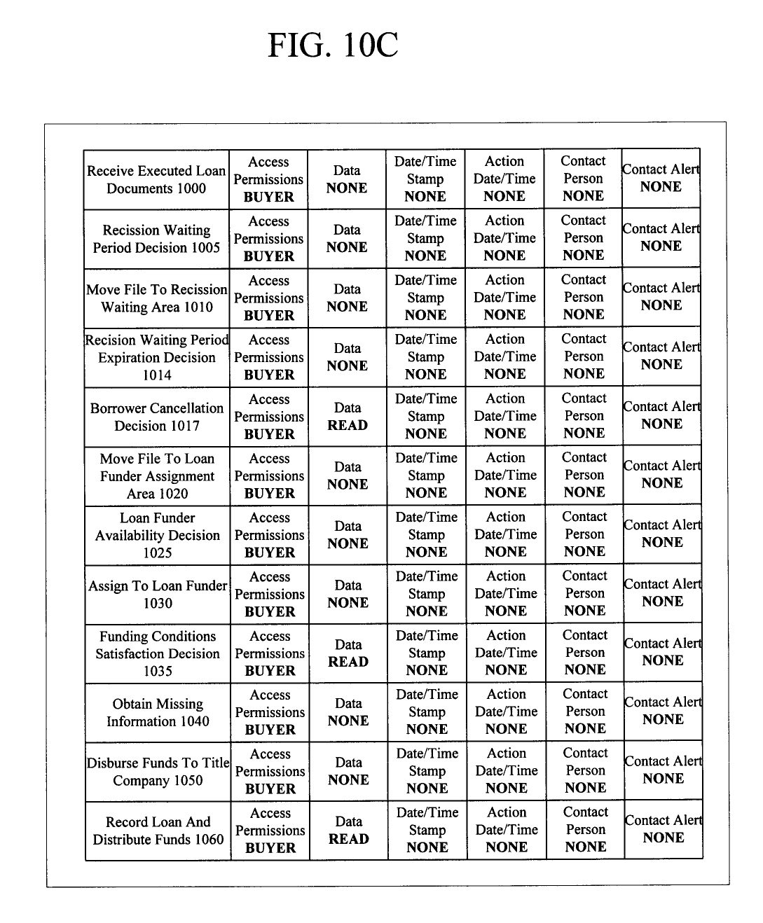

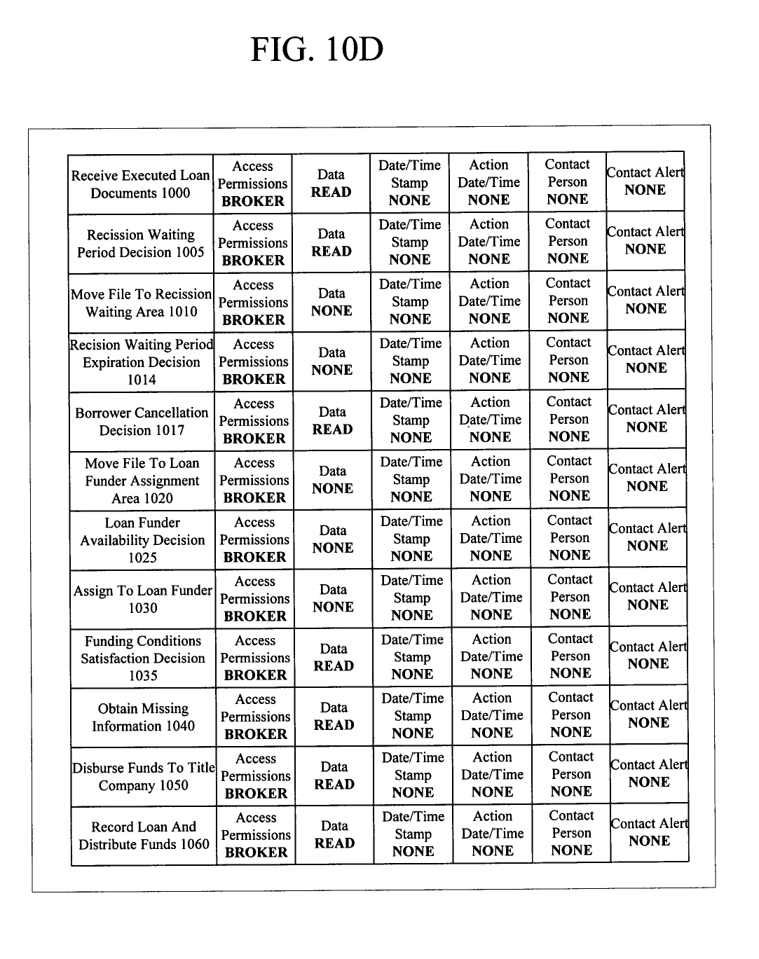

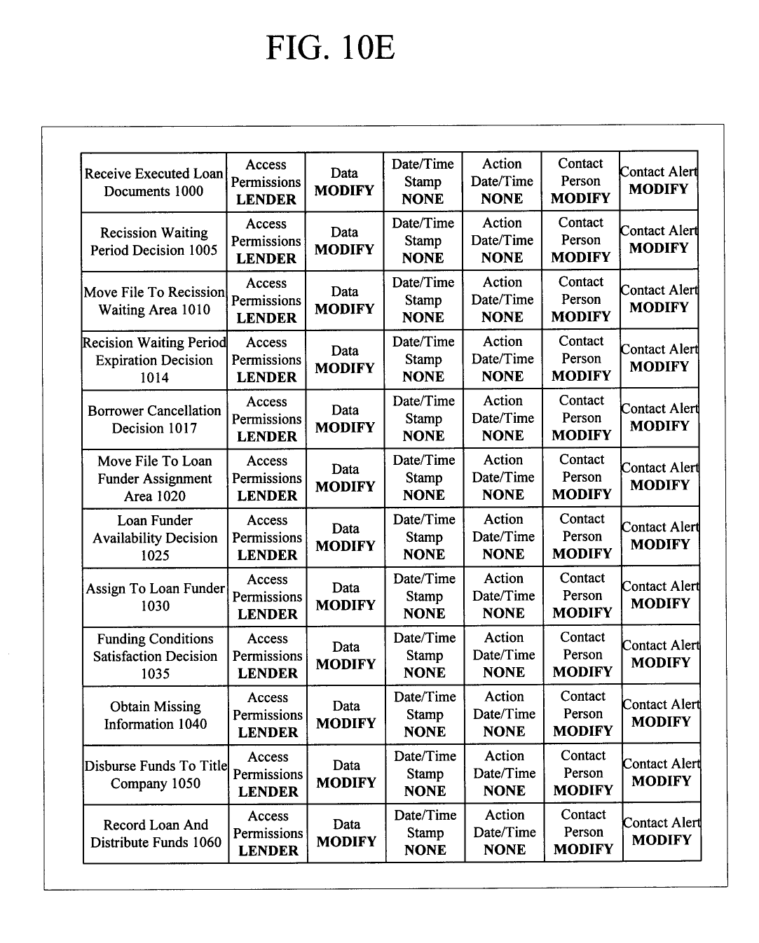

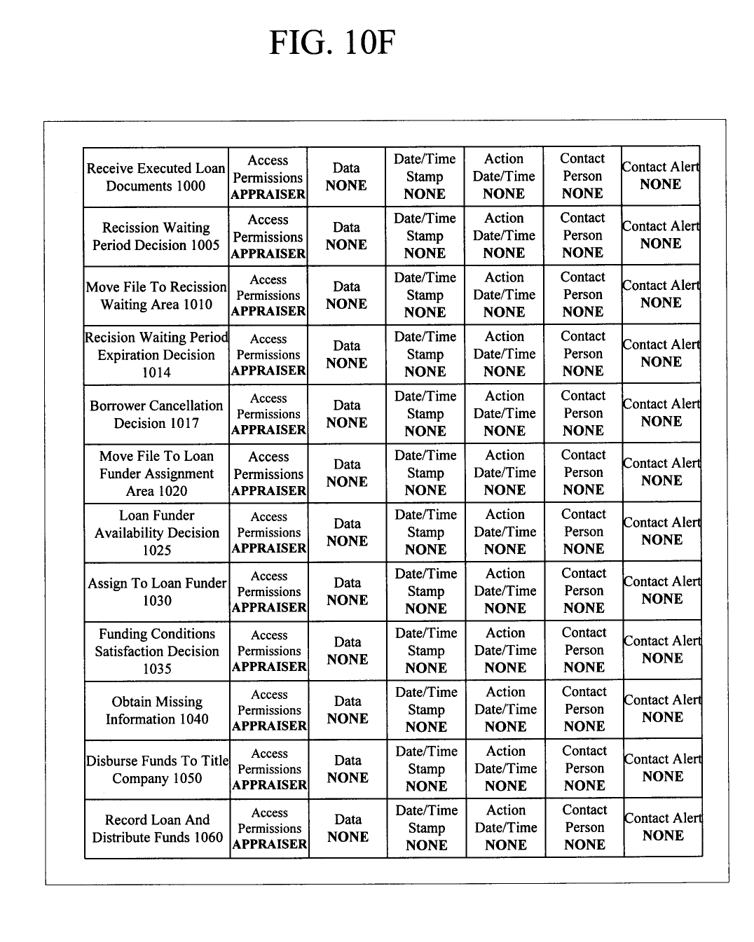

FIG. 10A shows transaction processing steps 1000, 1005, 1010, 1014, 1017, 1020, 1025, 1030, 1035, 1040, 1050, and 1060. FIG. 10B recites database fields 1000a, 1005a, 1010a, 1014a, 1017a, 1020a, 1025a, 1030a, 1035a, 1040a, 1050a, and 1060a, wherein those database fields comprises a portion of database fields 124. Each of the database fields recited in FIG. 10B corresponds to a method step recited in FIG. 10A.

FIG. 10C recites the access permissions allocated to the one or more BUYERS with respect to database fields 1000a, 1005a, 1010a, 1014a, 1017a, 1020a, 1025a, 1030a, 1035a, 1040a, 1050a, and 1060a. FIG. 10D recites the access permissions allocated to the one or more BROKERS with respect to database fields 1000a, 1005a, 1010a, 1014a, 1017a, 1020a, 1025a, 1030a, 1035a, 1040a, 1050a, and 1060a. FIG. 10E recites the access permissions allocated to the one or more LOAN OFFICERS with respect to database fields 1000a, 1005a, 1010a, 1014a, 1017a, 1020a, 1025a, 1030a, 1035a, 1040a, 1050a, and 1060a. FIG. 10F recites the access permissions allocated to the one or more APPRAISERS with respect to database fields 1000a, 1005a, 1010a, 1014a, 1017a, 1020a, 1025a, 1030a, 1035a, 1040a, 1050a, and 1060a.

While the preferred embodiments of the present invention have been illustrated in detail, it should be apparent that modifications and adaptations to those embodiments may occur to one skilled in the art without departing from the scope of the present invention.

We claim:

1. A method to monitor the status of a real-property transaction, comprising the steps of:
supplying a tracking system comprising a server comprising memory, a tracking database encoded in said memory, and a plurality of data input devices in communication with said server, wherein said database comprises a plurality of database fields, wherein one or more access permissions, a data field, a time stamp, an action time, one or more contact persons, and one or more contact alerts, are associated with said of said database fields;
initiating a new real-property transaction wherein a buyer is under contract to purchase real property;
creating in said database a new database entry associated with said new real-property transaction, wherein said new database entry comprises each of said plurality of database fields;
determining whether to maintain a hard copy file associated with said new real-property transaction;
operative if a hard copy file is maintained for said new real-property transaction:
generating a hard copy file; and
attaching a machine-readable label comprising a unique file identifier to said hard copy file, wherein said machine-readable label can be read by each of said plurality of data input devices.

2. The method of claim 1, wherein said supplying a plurality of data input devices comprises supplying a plurality of optical scanning devices.

3. The method of claim 2, wherein said attaching a machine-readable label step comprises attaching a bar code.

4. The method of claim 1, further comprising the steps of:
sequentially providing said hard copy file to a plurality of persons;
assigning a unique personal identifier to each of said plurality of persons;
providing one of said plurality of data input devices to each of said plurality of persons.

5. The method of claim 3, further comprising the steps of:
transferring at a first time possession of said hard copy file from a first person to a second person comprising a second person personal identifier;
entering in said new database file said first time, said file identifier, and said second personal identifier.

6. The method of claim 5, further comprising the steps of:
reading said machine-readable label using a data input device associated with said second person;
wherein said data input device associated with said second person provides said first time, said file identifier, and said second personal identifier to said server.

7. The method of claim 6, further comprising the steps of:
determining if said hard copy file has been misplaced;
operative if said hard copy file has been misplaced:
abstracting from said database, the latest time entry provided by one of said data input devices;
determining the person associated with said data input device providing said latest time entry;
providing a message to said person associated with said data input device providing said latest time entry, wherein said message requests the location of said hard copy file.

8. The method of claim 1, further comprising the steps of:
determining whether to utilize a wireless tracking device;
operative if a wireless tracking device is used:
providing a wireless tracking device; and
attaching said wireless tracking device to said hard copy file.

9. The method of claim 8, further comprising the steps of:
determining if said hard copy has been misplaced;
operative if said hard copy file has been misplaced, locating said hard copy file using said wireless tracking device.

10. The method of claim 1, further comprising the step of defining buyer access permissions for said buyer for each of said plurality of database fields associated with said new database entry.

11. The method of claim 10, further comprising the steps of:
receiving a request from said buyer to access a specified database field, wherein said specified database field comprises one of said database fields associated with said new real property transaction;
determining if said buyer access permission permit said buyer to access said specified database field;
operative if said buyer access permission permit said buyer to access said specified database field, granting said request from said buyer;
operative if said buyer access permission do not permit said buyer to access said specified database field, denying said request from said buyer.

12. The method of claim 1, wherein said buyer has engaged the services of a real estate broker, further comprising the step of defining broker access permissions for said real estate broker for each of said plurality of database fields associated with said new database entry.

13. The method of claim 12, further comprising the steps of:
receiving a request from said real estate broker to access a specified database field, wherein said specified database field comprises one of said database fields associated with said new real property transaction;
determining if said broker access permission permit said real estate broker to access said specified database field;
operative if said broker access permission permit said real estate broker to access said specified database field, granting said request from said buyer;
operative if said broker access permission do not permit said buyer to access said specified database field, denying said request from said real estate broker.

14. The method of claim 12, wherein said buyer is borrowing money from a financial institution employing a loan officer, further comprising the step of defining loan officer access permissions for one or more loan officers for each of said plurality of database fields associated with said new database entry.

15. The method of claim 14, further comprising the steps of:
receiving a request from said loan officer to access a specified database field, wherein said specified database field comprises one of said database fields associated with said new real property transaction;
determining if said loan officer access permission permit said loan officer to access said specified database field;
operative if said loan officer access permission permit said loan officer to access said specified database field, granting said request from said buyer;
operative if said loan officer access permission do not permit said buyer to access said specified database field, denying said request from said loan officer.

16. The method of claim 14, wherein said financial has engaged the service of an appraiser, further comprising the step of defining appraiser access permissions for each of said plurality of database fields associated with said new database entry.

17. The method of claim 16, further comprising the steps of:
receiving a request from said appraiser to access a specified database field, wherein said specified database field comprises one of said database fields associated with said new real property transaction;
determining if said appraiser access permission permit said appraiser to access said specified database field;
operative if said appraiser access permission permit said appraiser to access said specified database field, granting said request from said buyer;
operative if said appraiser access permission do not permit said appraiser to access said specified database field, denying said request from said loan officer.

18. The method of claim 1, further comprising the step of defining a contact person for each of said plurality of database fields associated with said new database entry.

19. The method of claim 18, further comprising the step of defining an alert contact for each of said plurality of database fields associated with said new database entry.

20. The method of claim 19, further comprising the step of defining an action time for each of said plurality of database fields associated with said new database entry.

21. The method of claim 20, further comprising the steps of:
selecting one of said database fields associated with said new database entry;
determining if the action time for said selected database field has been missed;
operative if the action time for said selected database field has been missed, providing a status message to the alert contact associated with said selected database field.
